(19) United States
(12) Patent Application Publication
(10) Pub. No.: US 2025/0315209 A1
(43) Pub. Date: Oct. 9, 2025

(54) ADAPTIVE VOICE CONTROLLED INTERFACE

(71) Applicant: SEBASTIAN.AI LLC, Hudson, MA (US)

(72) Inventor: John Eric Morales, Hudson, MA (US)

(21) Appl. No.: 19/169,902

(22) Filed: Apr. 3, 2025

Related U.S. Application Data
(60) Provisional application No. 63/574,154, filed on Apr. 3, 2024.

(51) Int. Cl. G06F 3/16; G06F 3/04812

(52) U.S. Cl. CPC G06F 3/167; G06F 3/04812; G06F 2203/04801

(57) ABSTRACT

The system introduces an evolutionary advance in enhancing human-computer interaction by integrating voice commands with manual input, structured through an Action-Object-Attribute-Variable (AOAV) framework. It enhances manual graphical interface navigation by integrating adaptive, voice-driven execution mapped directly to software elements. Core modules utilize BERT, ELMo, NER, and reinforcement learning (PPO) to interpret intent, maintain contextual continuity, and refine command accuracy. Anaphora Resolution allows natural, multi-step phrasing, while a Generative Adversarial Network (GAN) sharpens ambiguous inputs and CNN-based validation ensures precise UI targeting. A dynamic Interaction Manager synchronizes concurrent voice and manual inputs in real time. The system supports cloud-synced, multi-user collaboration with role-based adaptation. By reducing reliance on repeated cursor movements and manual clicks, it minimizes strain-related injury and expands accessibility for users with physical limitations. The result is an adaptive, predictive interface that transforms software interaction into faster, more natural, and inclusive experiences across creative, enterprise, and assistive software environments.

### CROSS-REFERENCE TO RELATED APPLICATION

This application claims the benefit of priority to U.S. Provisional Patent Application No. 63/574,154, filed on Apr. 3, 2024, titled “System and Method for Enhanced Human-Computer Interaction through Voice-Enabled Target Acquisition,” the contents of which are incorporated by reference herein in their entirety.

### BACKGROUND

Human-computer interaction (HCI) has traditionally centered around manual input mechanisms—such as mice, trackpads, styluses, and keyboards—to interact with graphical user interfaces (GUI). While these input methods have enabled significant productivity and creativity in software applications, they are fundamentally constrained by several longstanding limitations.

Manual User Interface (UI) Traversal Inefficiencies—Conventional GUI interactions typically require extensive manual navigation through layered menus, sub-menus, and nested panels to execute simple commands. Such cumbersome traversal processes introduce inefficiencies, slow down workflows, and significantly reduce productivity—particularly in creative and design-intensive software, where rapid iteration and experimentation are critical.

Repetitive Motion Injuries—Constant reliance on physical inputs like clicking, dragging, and typing frequently leads to repetitive strain injuries (RSI), particularly affecting creative and professional users who engage intensively with software interfaces.

Limited Adaptability and Personalization—Traditional input methods and GUI workflows do not effectively adapt to individual user behavior or evolving user preferences. Users must repeatedly navigate identical interface sequences even if their usage patterns clearly demonstrate consistent interaction patterns. The absence of adaptive mechanisms forces users into rigid, non-personalized workflows.

Accessibility Barriers—Users with motor impairments face significant barriers when relying solely on manual input methods, leading to reduced accessibility and constrained interaction capabilities with sophisticated software environments.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a Launch & Initialize Subsystem of the multimodal HCI platform, in accordance with some embodiments.

FIG. 2 illustrates a Voice Context Processing & Object Recognition Subsystem of the multimodal HCI platform, in accordance with some embodiments.

FIG. 3 illustrates an Interaction Reconciliation Subsystem of the multimodal HCI platform, in accordance with some embodiments.

FIG. 4 illustrates a Graphical User Interface Subsystem of the multimodal HCI platform, in accordance with some embodiments.

FIG. 5 illustrates a Voice to Object Logic Subsystem, Rendering & Execution Engine Subsystem, Refining & Learning Subsystem, and Host Application Subsystem of the multimodal HCI platform, in accordance with some embodiments.

FIGS. 6-12 illustrate an example user interaction with a GUI utilizing the multimodal HCI platform, in accordance with some embodiments.

FIGS. 13A-13G illustrate cross-functional flow diagram of an integrated voice and mouse interaction using the multimodal HCI platform, in accordance with some embodiments.

FIG. 14 illustrates a sequence of spoken natural language inputs tokenized into a structured format, in accordance with some embodiments.

FIG. 15 is a table of components used as part of anaphora resolution, in accordance with some embodiments.

FIG. 16 is a block diagram illustrating an example of a machine upon which one or more embodiments may be implemented.

### DETAILED DESCRIPTION

The multimodal platform described herein relates to HCI and intelligent automation in software applications. More specifically, it introduces a system and method for integrating voice commands with manual input, automatically interpreting, and executing software actions using an Action-Object-Attribute-Variable (AOAV) model.

The multimodal HCI platform leverages machine learning, Natural Language Processing (NLP), cloud-based synchronization, and adaptive user modeling to refine interaction over time, supporting multi-user workflows and cross-device session continuity. The primary focus of the multimodal HCI platform allows the system to respond to user inputs in a naturalistic, less technical, syntax-driven fashion, learning how humans speak naturally to accurately execute technical and precise operations. Further, by combining voice with manual input provides for a freer, more dynamic, more creative, and efficient interaction methodology. The methods and techniques described herein provide for the HCI paradigm to evolve from thoughtless, structure-dependent executioner to anticipative helper.

The methods and techniques described herein may be incorporated in, but not limited to, graphic design software, productivity tools, cloud-based applications, and artificial intelligence (AI) assisted collaborative environments where streamlined interaction may be crucial. The multimodal HCI platform may be particularly beneficial for users with accessibility needs, high-speed professional workflows, and multi-user collaboration environments.

Voice-command technologies and cloud-based AI present alternatives to manual GUI interactions. NLP, speech-to-text (STT), and voice-controlled assistants have partially addressed accessibility concerns and have improved user experiences by enabling hands-free interactions. However, existing solutions exhibit critical deficiencies, such as the following.

Lack of Structured Command Framework—Previous voice-driven interactions primarily process unstructured language commands, frequently resulting in ambiguous or misinterpreted execution. Without a standardized, structured command framework, the accuracy of voice-driven interactions remains suboptimal, resulting in frequent misunderstandings and operational errors.

Limited Contextual Understanding—Most current voice-based interfaces lack advanced contextual-awareness mechanisms, such as anaphora resolution or long-term session memory, which leads to ambiguity when users refer to previously selected UI elements (e.g., “Move this,” “Make it larger”) without explicit object references.

Absence of Multi-User and Cross-Device Integration—Current voice-driven solutions rarely integrate seamlessly with multi-user environments or cross-device workflows. They do not robustly adapt to personalized user roles, execution permissions, and collaborative workflows across multiple synchronized devices.

The present multimodal HCI platform addresses these critical limitations, transforming user interaction paradigms by integrating advanced voice interaction with manual input methods, thus enabling a new interactive dimension into human-computer interaction. The multimodal HCI platform provides improvements with the following features.

Dynamic AOAV Structuring Model—The multimodal HCI platform implements an innovative Action-Object-Attribute-Variable (AOAV) model that dynamically structures spoken commands into precise, standardized formats, drastically reducing ambiguities inherent in unstructured voice interaction.

The AOAV framework is an improvement by providing standardized categorization of user intent, that improves accuracy and minimizes command ambiguity.

Advanced Contextual Awareness & Anaphora Resolution—By employing deep learning-driven contextual embedding (ELMo), advanced NLP (BERT), and Named Entity Recognition (NER), the multimodal HCI platform maintains robust session continuity and resolves ambiguous references effectively. When a user provides a vague or incomplete reference, the system dynamically queries historical interactions, session contexts, and learned user preferences to accurately infer the intended object without requiring manual clarification. This results in enhancing workflow fluidity, speed, and user satisfaction.

Adaptive Refinement through Reinforcement Learning—The multimodal HCI platform employs reinforcement learning models (e.g., Proximal Policy Optimization (PPO), etc.) to adaptively refine the accuracy of command execution on a continuous basis. This refinement process ensures that the more users interact with the system, the more personalized, efficient, and accurate interactions become. Unlike static GUI systems or basic voice interfaces, the multimodal HCI platform actively evolves in direct response to user behavior and feedback, enhancing overall interaction efficiency and user satisfaction.

Dynamic Intent Refinement with Generative Adversarial Networks (GAN)—The integration of a GAN-based Intent Refinement model provides a unique capability that dynamically enhances execution certainty and resolving potential ambiguities proactively before committing changes to the graphical environment. This advanced technical solution significantly reduces user frustration arising from misunderstood commands, offering an improvement over existing voice-based interfaces.

Convolutional Neural Network (CNN)-Based UI Element Validation—Incorporating CNN technology for object detection and validation of GUI elements ensures precise visual verification of targeted objects. The system may proactively prevent execution errors that plague existing voice-driven interfaces due to ambiguous visual object referencing. This precise, visually informed validation significantly surpasses existing object-mapping methods used in current voice-driven interfaces.

Harmonized Multimodal Interaction—Greater than the Sum of Parts—The multimodal HCI platform uniquely combines voice and manual inputs, not merely as independent modes but as a synchronized interactive system. This provides for simultaneous, complementary use of voice-driven AOAV structuring and manual UI interactions, each mode reinforcing the accuracy and efficiency of the other. The result is a harmonized interaction methodology significantly more intuitive, efficient, and naturalistic, thus creating an entirely new “interaction dimension” that enhances productivity and creative fluidity. The interactive flow between modalities becomes significantly richer and more efficient than either manual or voice interaction alone, representing a fundamental advance over existing single-modal interaction paradigms.

Personalized, Multi-User, and Cross-Device Adaptability—The system employs cloud-based synchronization to ensure persistent personalization and continuous session management across multiple users and devices. This adaptability, combined with role-based permissions and interaction histories, allows a personalized and context-aware interaction environment far surpassing prior art in flexibility, personalization, and efficiency.

By injecting advanced AI-driven voice interaction within a structured AOAV framework, seamlessly synchronized with traditional manual inputs, the multimodal HCI platform overcomes longstanding limitations of conventional interaction methods. Its sophisticated integration of contextual embedding, reinforcement learning-driven refinements, GAN-based intent refinement, and CNN-driven UI validation may result in a dynamic, contextually accurate, and adaptive interaction paradigm. Consequently, it fundamentally elevates human-computer interaction beyond the sum of its individual components, achieving an unprecedented level of intuitive, efficient, and accessible computing interaction.

The multimodal HCI platform introduces systems and methods for significantly enhancing HCI through a novel integration of voice commands and manual input (e.g., mouse, trackpad, keyboard, touchscreen, etc.), structured dynamically using an AOAV parsing framework. The multimodal HCI platform replaces conventional methods of manual GUI traversal or interaction with contextually adaptive, voice-driven commands processed directly into executable actions. Typical GUI interaction may require extensive menu navigation and repetitive cursor movements. The system comprises interconnected AI-driven modules operating in concert, specifically utilizing advanced natural language processing NLP, context-aware embeddings, reinforcement learning, and convolutional and generative neural networks.

Central to the multimodal HCI platform is the dynamic parsing and structuring of spoken input into AOAV-based commands, which are then accurately mapped to GUI elements or software components. The integration of AOAV structuring with deep learning models, including a Generative Pre-trained Transformer (GPT), Bidirectional Encoder Representations from Transformers (BERT), Embeddings from Language Models (ELMo), and Named Entity Recognition (NER), enables precise intent extraction and object identification within multi-step user interactions. By utilizing reinforcement learning algorithms, specifically Proximal Policy Optimization (PPO), the system adaptively refines command interpretation, execution accuracy, and contextual object referencing based on historical user behavior and real-time feedback.

The multimodal HCI platform incorporates an Anaphora Resolution mechanism implemented within a dedicated User Context Manager component, leveraging NLP models, such as BERT, ELMo, and NER. This may provide for ambiguous voice references (e.g., “move it there,” “make this larger”) to be accurately linked to previously identified or interacted graphical objects, significantly improving accuracy and user efficiency in complex, multi-step workflows.

Furthermore, a robust Intent Refinement mechanism employs a GAN to dynamically refine the accuracy of AOAV command mapping, significantly reducing ambiguity before execution. A CNN-based Object Mapping & Detection module validates UI object selections visually, ensuring high-precision alignment between spoken commands and graphical execution. The dynamic prioritization of concurrent manual and voice-driven interactions is managed by an Interaction Integrator, which utilizes reinforcement learning models to continuously optimize input prioritization logic based on learned interaction patterns.

To support complex collaborative scenarios, the multimodal HCI platform includes intelligent multi-user synchronization, session persistence, and role-based permission management, dynamically adapting AOAV execution workflows according to personalized user profiles and interaction histories across cloud-synchronized, multi-device environments.

The present multimodal HCI platform provides advanced systems and methods designed to fundamentally transform human-computer interaction HCI by seamlessly integrating adaptive voice commands with traditional manual input mechanisms, such as mouse, keyboard, trackpad, touchscreen, or stylus, to provide highly accurate, efficient, and contextually-aware software operations. This integration employs a structured AOAV command frame-work, AI-driven intent interpretation, dynamic resolution of ambiguities, and reinforcement learning-based adaptive optimization. As a result, the multimodal HCI platform creates a multi-modal interaction paradigm that improves previous manual-only and voice-only in-put methodologies and may deliver a user experience superior to those achievable by conventional means.

The system initiates interaction by receiving user input through voice commands that are converted to structured textual data via speech-to-text processing component, leveraging deep learning architectures, such as a Recurrent Neural Network (RNN) combined with Connectionist Temporal Classification (CTC) to achieve transcription accuracy and clarity. Following transcription, the NLP & AOAV Structuring component 530 processes and transforms spoken language into an actionable AOAV structured format using deep learning-driven language models GPT, BERT, NER, and context-sensitive embeddings ELMo.

Central to resolving common ambiguities inherent in voice interactions, the multimodal HCI platform integrates a specialized Anaphora Resolution capability within the User Context Manager 540. This component leverages BERT-based intent recognition, contextual word embeddings from an ELMo, and historical interaction patterns stored within User Context & Preferences Storage 301 to resolve vague or implicit object references dynamically. Through the anaphora resolution mechanism, the system may accurately interpret and seamlessly maintain context across complex, multi-turn user interactions, reducing user input errors and increasing overall system reliability.

The multimodal HCI platform incorporates adaptive learning components, featuring PPO-based reinforcement learning. This adaptive learning capability may analyze and iteratively refine command recognition and execution based on historical interaction patterns, usage behaviors, and real-time user feedback. By learning user-specific workflows, speech patterns, and frequent interaction scenarios, the system may continuously improve parsing accuracy, intent resolution, and operational responsiveness. Consequently, each successive interaction may results in improved command precision, reduced cognitive load, and optimized workflow efficiency tailored specifically to individual users or role-based scenarios.

The multimodal HCI platform includes the application of advanced neural network architectures, such as CNN and GAN, designed specifically to address unique HCI challenges, such as CNN-based Object Mapping & Detection and GAN-based Intent Refinement.

CNN-based Object Mapping & Detection—Before command execution, the CNN-based component may visually verify the intended graphical interface elements, to provide accurate identification of GUI objects. This visual validation may reduce potential errors resulting from misinterpretation or ambiguous references.

GAN-based Intent Refinement—To further enhance execution accuracy, the multimodal HCI platform employs a GAN-based intent refinement method, dynamically analyzing potential execution outcomes and resolving ambiguities before command execution. This predictive validation process may reduce the frequency of execution errors and unnecessary user clarifications.

The interaction processing and execution are managed by a Interaction Reconciliation Engine 300, which integrates both manual input and voice command streams into a coherent interaction model. By prioritizing interactions intelligently through a interaction manager component 610, the system may provide precise execution sequencing, arbitration between manual and voice-based commands, and real-time conflict resolution, thereby enhancing user usability and workflow fluidity.

The multimodal HCI platform's graphical rendering subsystem 620 provides real time and accurate visual representation of executed AOAV commands. By integrating closely with the validated AOAV command data, the rendering component provides real-time feedback and confirmation of user actions. This feedback mechanism may reinforce user confidence and reduces cognitive effort, allowing users to focus on their creative or productive tasks rather than interface mechanics.

Moreover, the multimodal HCI platform is designed to operate seamlessly within collaborative multi-user environments. Through cloud-based synchronization and session continuity, the system may dynamically adapt to user-specific preferences, workflows, and permissions across multiple devices and shared workspaces. This may provide continuous and personalized interaction experiences that elevate multi-user collaboration.

In practical application, this multimodal HCI platform is beneficial in complex and precision-intensive fields, such as graphic design, video editing, gaming, enterprise productivity, education, assistive technologies, and collaborative software environments. Its integration of voice and manual inputs provides an interactive dimension that may accelerates workflows, reduce repetitive motion injuries, improve accessibility for users with physical impairments, and foster creative flexibility through intuitive, conversational interfaces.

Ultimately, the synergistic integration of structured AOAV command modeling, contextual anaphora resolution, CNN-driven visual validation, reinforcement learning-based adaptive optimization, GAN-based predictive refinement, and multi-modal interaction arbitration produces a dynamic, intelligent system.

The multimodal HCI platform may delivers technological advancements applicable across diverse industries, providing efficiency, precision, accessibility, and intuitiveness of human-computer interaction through the integration of structured voice command parsing AOAV, adaptive machine learning, and manual interaction modalities. Below are some, but not all, examples that may illustrate the applicability and technological value of the multimodal HCI platform across multiple technical domains and scenarios.

Creative and Digital Design Software Applications—In software involving complex graphical user interfaces, such as graphic design, photo/video editing, or 3D modeling tools, the multimodal HCI platform may accelerate workflows through context-aware voice commands combined with precise manual refinements. The AOAV structuring enables users to invoke complex tool operations (e.g., “Resize this element proportionally by 120%,” “Apply Gaussian blur of 2 px radius”) accurately and instantly. By leveraging CNN-driven GUI element validation and adaptive PPO-based learning from previous user interactions, the system accurately maps commands to targeted objects within dense graphical layouts, reducing task execution latency and physical fatigue.

Collaborative Software Environments—In software used for collaboration, teamwork, and multi-user editing environments (e.g., design studios, collaborative CAD software, team-based document editing, etc.) the multimodal HCI platform introduces intelligent, role-based AOAV interactions. Multi-user synchronization through cloud-stored user-contexts ensures personalized, adaptive AOAV command execution based on historical user interactions, access permissions, and collaboration context. This ensures smooth, simultaneous interactions from multiple users within a shared digital environment, maintaining consistency and workflow harmony greater than conventional collaborative tools that lack integrated, adaptive voice- and manual-driven controls.

Accessibility and Inclusive Computing—The multimodal HCI platform may enhance accessibility for users facing motor or mobility challenges. By structuring spoken commands via the AOAV model and employing anaphora resolution techniques, individuals may perform intricate GUI interactions that previously necessitated complex manual dexterity. Commands, such as “Move the highlighted object here,” “Rotate this 90 degrees clockwise,” or “Change this color to blue,” may become feasible without precise motor input, thus enhancing accessibility. Reinforcement learning dynamically adapts to unique speech patterns and interaction behaviors, further personalizing interactions to accommodate diverse accessibility needs.

Workflow Efficiency and Enterprise Productivity Enhancement—The multimodal HCI platform may reduce interaction friction by replacing repetitive manual GUI traversals with adaptive voice-based AOAV parsing, that may be relevant to workflow-intensive environments, such as digital content creation, data analytics, or software development. Users execute complex sequential commands swiftly without traversing menus or memorizing shortcuts. GAN-based intent refinement ensures minimal ambiguity, while reinforcement learning continuously optimizes workflows based on evolving user behavior. This directly addresses common productivity bottlenecks and significantly reduces repetitive-motion injuries resulting from extensive manual GUI navigation.

Real-Time Industrial and Commercial Applications—In industrial and commercial software contexts, the AOAV-based interaction method may reduce execution time and errors during complex control operations. Operators may vocally execute intricate command sequences, navigating dense operational interfaces instantly and accurately, verified visually by CNN-based object validation component before execution. For example, operators may rapidly adjust machine parameters, perform precise data entry, or navigate through complex inventory interfaces by combining voice and targeted manual interventions. AOAV structuring provides command precision and operational clarity, minimizing costly misinterpretations or errors inherent in prior voice-command systems.

Healthcare and Accessibility Assistive Technologies—Healthcare software and assistive technologies may benefit from the multimodal HCI platform's adaptive voice integration, structured AOAV framework, and user-context awareness. Practitioners may invoke medical software functions using voice-driven interactions, validated visually and contextually through CNN-based object verification. For example, imaging software commands may include “Zoom this area by 150%,” “Highlight abnormal tissue here,” or “Archive patient record now.” This may reduce task execution time, eliminate manual cursor-navigation complexities, and expand accessibility for medical personnel or patients facing physical limitations.

Multi-Device Synchronization and Mobility Contexts—The multimodal HCI platform may address mobility-driven use cases that may require consistent user experiences across multiple devices desktop, mobile, wearables, AR/VR interfaces. By synchronizing AOAV interaction models, user context, and adaptive learning profiles through cloud infrastructures, users experience seamless interactions irrespective of the current device or environment. Real-time AOAV command parsing, adaptive context synchronization, and personalized reinforcement learning may provide continuous, device-agnostic interaction experiences tailored to user behavior and context.

Virtual Reality (VR), Augmented Reality (AR), and Gaming Environments—AOAV-structured voice integration may elevate interactive experiences within VR, AR, and gaming environments. By interpreting complex commands (e.g., “Equip this item and rotate 30 degrees left,” “Move that object there and duplicate it”), the multimodal HCI platform fundamentally enriches immersive interaction modalities. Real-time GAN-driven intent refinement, CNN-based visual object validation, and adaptive PPO reinforcement learning collectively ensure immersive and error-free command execution, providing fluidity, immersion, and intuitive interaction.

Educational and Creative Design Applications—Educational software, creative tools, and design applications may benefit from the multimodal HCI platform's integration of adaptive AOAV command execution and manual refinement. Students and creative professionals may gain productivity, reduced cognitive load, and enhanced creative freedom by executing complex interactive steps intuitively through structured voice commands (e.g., “Duplicate this component five times, arrange horizontally, and align evenly”). Adaptive PPO refinement optimizes execution accuracy over repeated use, while GAN-based predictive intent refinement reduces execution ambiguity, thereby accelerating the learning process, boosting creativity, and improving educational accessibility.

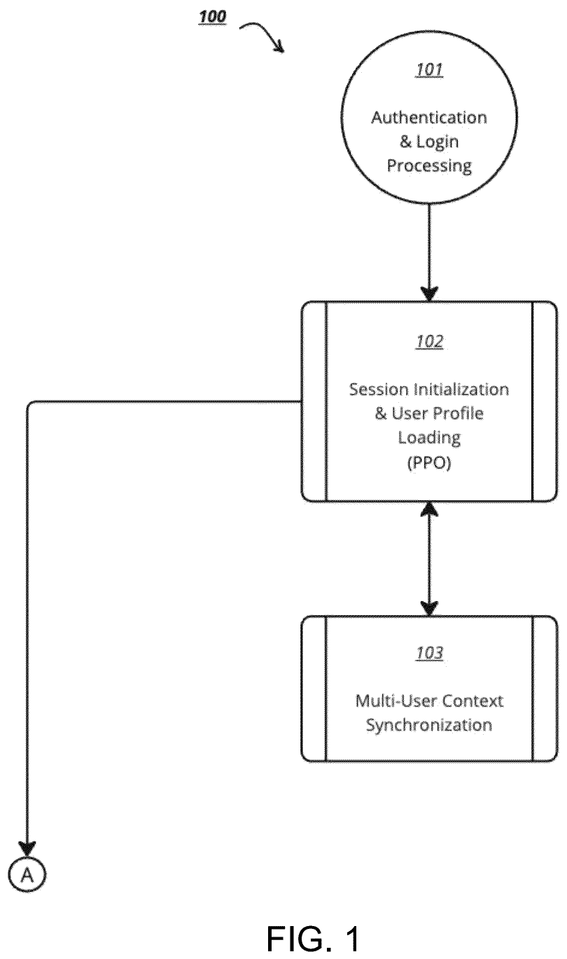

FIGS. 1-5 illustrate the subsystems that comprise the multimodal HCI Platform. FIG. 1 illustrates a Launch & Initialize Subsystem 100 of the multimodal HCI platform, in accordance with some embodiments. The Launch & Initialize Subsystem 100 governs the initial system entry point by establishing the operational environment based on the identity and context of the user. This subsystem comprises Authentication & Login Processing 101, Session Initialization & User Profile Loading 102, and Multi-User Context Synchronization 103, which collectively authenticate the user, load session-specific preferences, and configure the shared or personal execution environment based on role-based access and collaboration logic.

In some embodiments, system interaction is triggered by user presence or credential entry. Authentication & Login Processing 101 may validate the identity of the user using locally stored credentials or remote identity providers (e.g., third party validation services). Upon successful authentication, the system may retrieve, from User Context & Preferences Storage 301, the user's profile, which may include AOAV structuring preferences, historical interaction records, role designations, and device configurations. These records are stored in the User Context & Preferences Storage 301, a component of the Refining & Learning Subsystem 700, that is cross platform and provides for continuity between sessions and personalized behavior.

Following authentication, Session Initialization & User Profile Loading 102 configures the current environment. The system may preload high-frequency AOAV token clusters and command patterns based on previously recorded usage. These preloaded parameters are then made available to the User Context Manager 540, as part of Voice to Object Logic Subsystem 500, and the Intent Resolution system 550, informing initial parsing rules and command execution behavior. User-specific execution workflows may be restored to accelerate contextual understanding and eliminate repetitive onboarding steps.

For team-based environments, Multi-User Context Synchronization 103 may be activated to establish synchronized execution boundaries between multiple concurrent users. The system may determine whether the user has administrative authority or operates as a contributor. In the case of administrative users, the AOAV execution layer may prioritize their commands for system-wide propagation, whereas contributor users may have scoped privileges limited to individual objects or sandboxed workspaces. These policies may be configured dynamically via synchronized user roles received from User Identity & Permissions Input 510, ensuring that AOAV intent matching and object selection behavior conform to organizational access policies.

If two or more users initiate potentially conflicting commands, Launch & Initialize Subsystem 100 triggers arbitration by routing control through Intent Resolution 209, with adjudication guided by the command's AOAV structure, command priority, role weighting, and command timing. For example, a “delete” command by a contributor on a shared element already being modified by an administrator may be deferred or rejected with a feedback prompt issued through Audio/Visual Feedback 720.

The initialization flow may also push session-specific AOAV context into Learning & Adaptive Refinement 710, creating a bidirectional link that informs the system of preferred interaction models and evolves execution models over time. This includes adjusting AOAV token cluster weights, reinforcement feedback from prior session success rates, and language pattern normalization across users, roles, and devices.

Launch & Initialize Subsystem 100 serves as the foundational bootstrap for intelligent interaction by integrating with User Context Manager 540, Object-to-Token Linking & Intent Resolution 550, Learning & Adaptive Refinement 710, and Feedback Processing 720. Launch & Initialize Subsystem 100 provides that speech commands and manual inputs issued immediately after login are interpreted in the context of each user's historical patterns, preferences, role permissions, and session state continuity. In doing so, it enables a seamlessly adaptive system environment optimized for AOAV-based interaction from the first utterance or input.

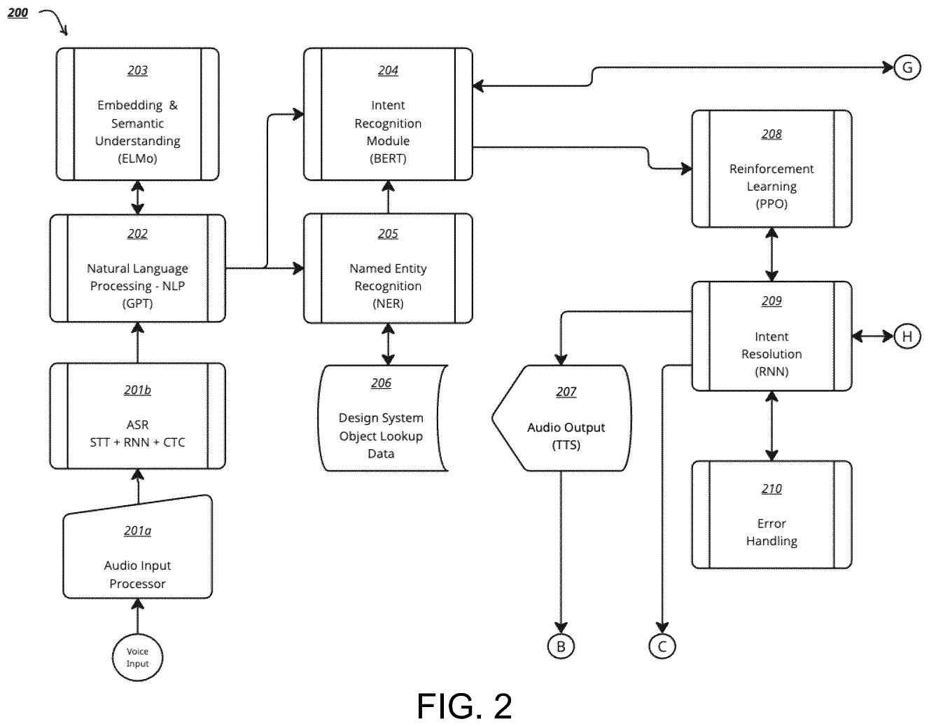

FIG. 2 illustrates a Voice Context Processing & Object Recognition Subsystem 200 of the multimodal HCI platform, in accordance with some embodiments. The Voice Context Processing & Object Recognition Subsystem 200 is responsible for interpreting, contextualizing, and structurally encoding user voice input into actionable commands for execution within the graphical interface. The Voice Context Processing & Object Recognition Subsystem 200 includes multiple cooperative components—each tasked with advancing raw speech data into a refined and tokenized AOAV structure, while preserving contextual relationships, resolving linguistic ambiguity, and adapting over time to user-specific interaction patterns.

The process may begin when the user's speech 570 is routed through the Voice Input Recognition & Filtering component 560, where the host operating system or hardware interface may apply preliminary voice filtering, ambient noise cancellation, and speech activity detection. From there, the audio stream is passed to Audio Input Processing 201a, which may perform fine-grained signal pre-processing, such as normalization, echo suppression, and signal windowing. The cleansed waveform is then forwarded to the Speech-to-Text Processing 201b, where automatic speech recognition (ASR) is performed using a deep learning-based model, such as RNN and CTC, to produce a text-based transcript of the spoken input.

The output from Speech-to-Text Processing 201b is passed to Natural Language Processing 202, which parses the transcript into tokens, analyzes syntactic structure, and detects the functional intent of the sentence. Natural Language Processing 202 plays a foundational role in aligning each phrase with its likely software command structure, identifying linguistic markers corresponding to the AOAV token structure where AOAV is parsed into Actions (verbs), Objects (nouns), and Attributes and/or Variables (adjectives, prepositional phrases, numerical qualifiers).

To improve semantic understanding, the token stream is passed to Embedding & Semantic Understanding 203, which utilizes context-aware embeddings, such as ELMo, to derive relational meaning between terms and to maintain conversational context over successive commands. The output from Semantic Understanding 203 is an enriched token set organized into a candidate AOAV structure, which is then passed to Intent Recognition 204.

The Intent Recognition component 204 uses a BERT model to perform both syntactic disambiguation and contextual disambiguation. For example, in a command like “Make this larger,” the system determines whether “this” refers to a specific object previously mentioned or selected, utilizing both current AOAV token proximity and previously parsed context.

Entity resolution is handled cooperatively between Named Entity Recognition (NER) 205 and Design System Object Lookup 206. NER 205 evaluates the object token cluster using a model trained on domain-specific entities, identifying recognized UI elements or software primitives (e.g., “button,” “header,” “panel”) and assigning them a confidence weight. These entities are then validated against a local or cloud-based object catalog within Design System Object Lookup 206, which ensures that the named object exists in the current session context, such as a Figma design system, a PowerPoint layout, or other integrated design environments.

Throughout this layered interpretation flow, Reinforcement Learning 208 is employed to refine parsing and resolution strategies over time. This may be implemented using PPO where the learning mechanism adjusts the interpretation weights of specific AOAV token sequences, command patterns, and ambiguity resolutions based on successful or corrected executions from prior sessions. These refinements are not limited to intent recognition but may extend to improving synonym handling, phrase completion, and implicit attribute resolution across multiple languages or interaction styles.

When command ambiguity persists or confidence thresholds fall below predefined limits, the system may activate Intent Resolution 209, as part of the Interaction Reconciliation Engine Subsystem 300, where the input command is held, and a clarification signal is generated. The command is routed through Feedback & Error Handling 720, which may prompt the user through Audio Output 207 (e.g., via Text-to-Speech) or display the interpreted command in Voice Command Display Panel 402 for confirmation or correction. This interaction may also feed back into Reinforcement Learning 208, further refining the system's understanding of contextual correction behavior.

In some embodiments, verbal acknowledgments, system-generated feedback, or confirmations may be delivered using Text-to-Speech Output 207, ensuring a real-time dialogue between the user and the system. These responses help bridge the cognitive gap between spoken instruction and system action, creating a more intuitive interface for design, control, or navigation workflows.

Collectively, Voice Context Processing & Object Recognition Subsystem 200 transforms raw voice input into precise, structured AOAV intent representations through a cascade of contextual, semantic, and structural refinements. Voice Context Processing & Object Recognition Subsystem 200 may interpret language, as well as continuously learn and adapt, to enable reliable, fluid voice interaction across a broad spectrum of graphical user interface environments.

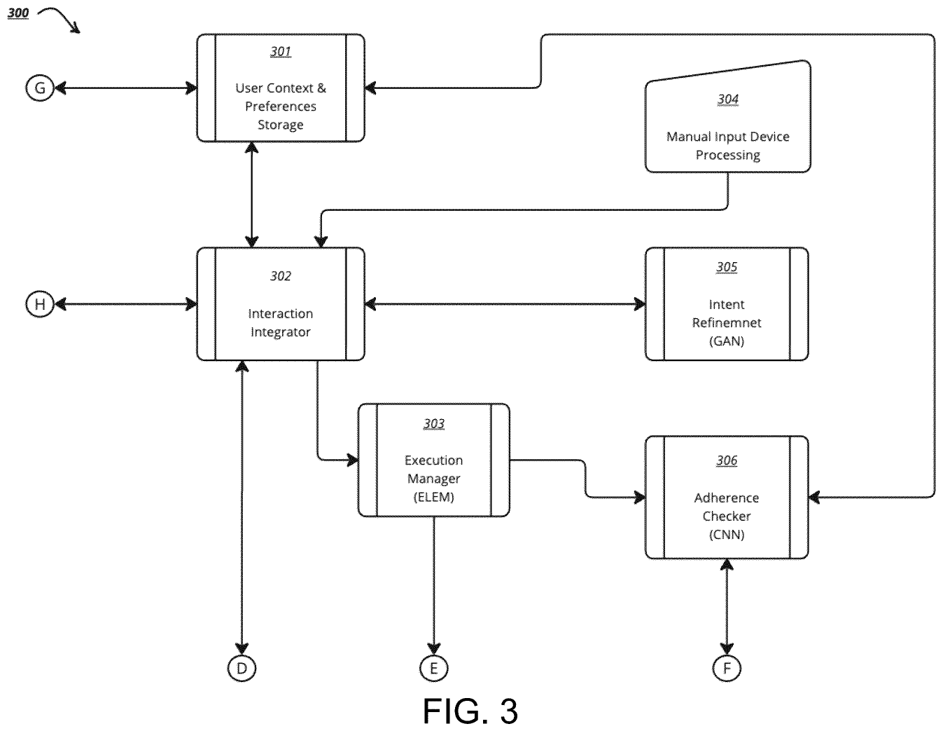

FIG. 3 illustrates an Interaction Reconciliation Subsystem 300 of the multimodal HCI platform, in accordance with some embodiments. The Interaction Reconciliation Engine Subsystem 300 serves as the central logic system for coordinating, refining, and executing user commands that may originate from either voice input or manual device interaction. The Interaction Reconciliation Engine Subsystem 300 functions as an arbitration and orchestration layer that ensures all AOAV-structured instructions are contextually validated, prioritized, and routed through a consistent execution pathway while aligning with manual input (e.g., mouse, keyboard, touchscreen, etc.), the user's personalized interaction history, and any multi-user policy constraints.

In some embodiments, the reconciliation process may begin by accessing User Context & Preferences Storage 301, which maintains a comprehensive log of the user's historical interactions, AOAV structuring preferences, and learned behavioral patterns. This data may include previously issued command patterns, manual override tendencies, cursor usage trends, and timing sequences between speech and touch inputs. User Context & Preferences Storage 301 may serve as a persistent profile repository for role-based access control, enabling enforcement of user-specific execution permissions in shared or collaborative environments.

Command signals, whether from Voice Context Processing & Object Recognition Subsystem 200 (e.g., voice input) or Host Application Subsystem 800 (e.g., mouse, keyboard, touchscreen), may be passed into Interaction Integrator 302, which acts as the coordination layer for harmonizing multi-modal input signals. In some embodiments, Interaction Integrator 302 may prioritize commands based on a combination of heuristics and timing logic, resolving potential conflicts using input hierarchy rules. For instance, speech input may dominate action-based commands (e.g., “place a red circle”, “draw a square”), while manual input may take precedence for spatial interactions, such as precise object placement or dragging. In collaborative workflows, the integrator may also invoke role-based arbitration logic, consulting execution permissions and deferring certain commands if originating from a non-authorized user.

If the command under review involves any real-time manual input (e.g., a mouse click, cursor hover event), Manual Input Device Processing 304 may be utilized. Manual Input Device Processing 304 continuously listens to input device signals and provides the system with spatial feedback, such as object selection states, hover locations, and region-based activity, to provide any downstream AOAV command is contextually aligned with the user's real-time focus within the GUI environment. In cases where voice and manual inputs are both active, Manual Input Device Processing 304 may assist Interaction Integrator 302 in mapping gesture context to spoken command sequences, for example resolving “make this bigger” with the UI element at the current location of the mouse cursor.

Once signals have been contextually reconciled, the full AOAV command is passed to Execution Manager 303, which in some embodiments may be implemented using an Event Loop Execution Model (ELEM) architecture. The purpose of Execution Manager 303 is to sequence the finalized AOAV intent into a machine-executable format, scheduling the action through an internal event dispatch loop. This provides for interruptible, asynchronous handling of multiple command streams and provides a foundation for orderly execution of high-frequency, low-latency user interactions. The Execution Manager 303 also monitors for cancellation or override events—either system-generated or user-driven—before committing the command for downstream execution.

To further refine execution precision, the AOAV command may be preprocessed by Intent Refinement Component 305, which utilizes a GAN to model the likelihood and appropriateness of the intended action based on past successful executions and high-confidence command structures. The GAN may act as a probabilistic filter, reducing ambiguity in intent mapping by generating alternate interpretation hypotheses and comparing them to the original resolution. If the confidence score of the command remains low after refinement, the system may route the action to Audio/Visual Feedback 720, prompting the user for confirmation, correction, or clarification.

Concurrently, the Adherence Checker 306 evaluates the finalized command against a body of design best practices and user-defined templates, such as Web Content Accessibility Guidelines (WCAG) for accessibility adherence, or an organizational brand style guide. The Adherence Checker 306 may compare the proposed execution against previously accepted behavior patterns stored in User Context & Preferences Storage 301 or reference externally defined standards (e.g., accessibility guidelines or enterprise consistency rules). In the event that the action diverges significantly from accepted practices, Adherence Checker 306 may issue a warning, suggest an alternative command, or delay execution pending user review through Visual Feedback 720 (e.g., display on a screen).

Upon successful completion of all reconciliation and validation steps, the resolved AOAV instruction may be forwarded to Rendering & Execution Subsystem 600 for action, including transmission to Interaction Manager 610 and rendering via Graphical Rendering 620.

Thus, Interaction Reconciliation Engine Subsystem 300 provides ensures that multi-modal user input—whether from natural language or direct manual device input—is consistently interpreted, validated, and routed for execution with contextual precision, dynamic adaptability, and multi-user governance. By combining intent resolution, event-loop dispatch, generative refinement, and standards adherence, the Interaction Reconciliation Engine Subsystem 300 serves as the intelligent arbitration layer that guarantees system responsiveness, safety, and user-aligned behavior in complex GUI-driven workflows.

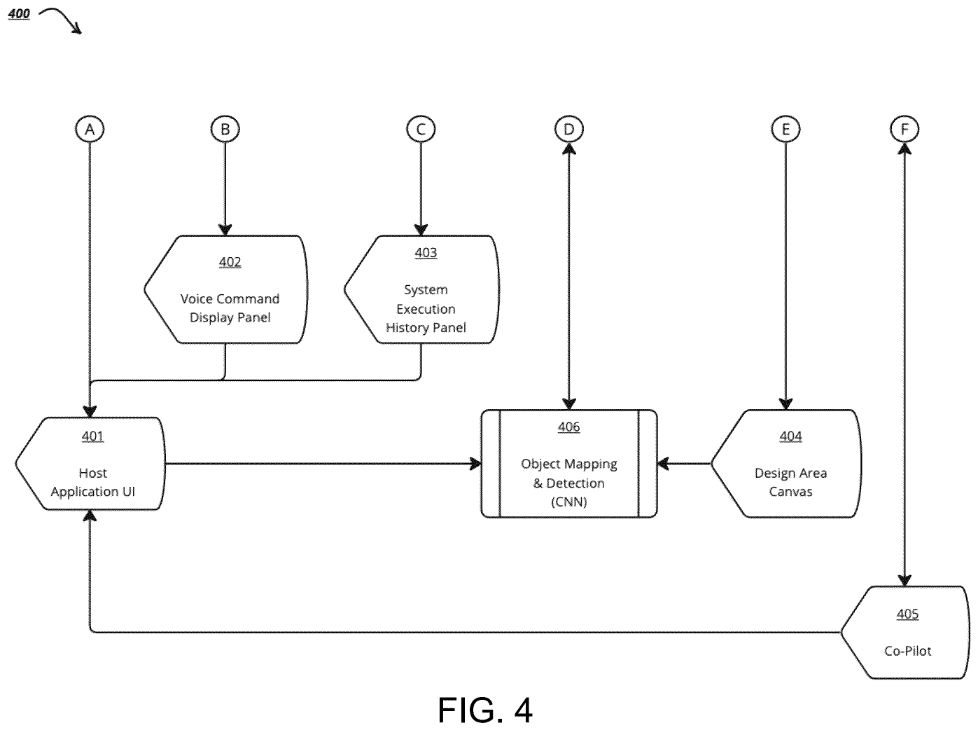

FIG. 4 illustrates a Graphical User Interface Subsystem 400 of the multimodal HCI platform, in accordance with some embodiments. The Graphical User Interface Subsystem 400 serves as the visual interaction environment for the user and provides real-time, multimodal feedback for voice-commands and manually-driven inputs. In some embodiments, Graphical User Interface Subsystem 400 dynamically renders software state changes initiated by AOAV-parsed commands, tracks user interactions, confirms command interpretations, and ensures accuracy in object targeting and modification via visual verification mechanisms. The Graphical User Interface Subsystem 400 comprises several interface layers and display regions, each performing a distinct interaction or visualization function.

The system may initiate operation of the Graphical User Interface Subsystem 400 when an AOAV command, which was previously parsed and resolved upstream by the Voice to Object Logic Subsystem 500 and Interaction Reconciliation Engine Subsystem 300, is passed to the rendering pipeline. At this point, a coordinated visual update is executed within the GUI display architecture, beginning at Main UI Layer 401, which serves as the primary viewport for all graphical elements, panels, and windows. The GUI layer may include native host application elements, as well as additional overlay windows generated by the multimodal HCI platform's interaction framework.

The user's speech-driven input, as processed by the Voice Context Processing & Object Recognition Subsystem 200 and the Interaction Reconciliation Engine Subsystem 300, is visually confirmed in real time through Voice Command Display Panel 402, which renders structured AOAV interpretations for transparency, confirmation, and learning reinforcement. In some embodiments, this may also include clarifications generated from Audio/Visual Feedback 720, providing users to visually monitor voice recognition and AOAV translation accuracy.

Simultaneously, the System Execution History Panel 403 may log each confirmed or rejected AOAV instruction, including execution outcomes, system responses, and user interventions. This provides a persistent, scrollable command trail that supports both transparency and debugging. In learning-centric or collaborative implementations, System Execution History Panel 403 may also expose system refinement logs derived from Learning & Adaptive Refinement 710 offering visibility into how prior feedback shaped the command pipeline.

At the core of user interaction lies the Design Area Canvas 404, a live workspace where selected or targeted objects are displayed and modified. All AOAV-executed changes—whether voice-initiated modifications, manual adjustments, or hybrid interactions—are visualized here. For instance, if a user states, “Increase the stroke of this rectangle,” the system renders the modification in Design Area Canvas 404.

The Co-Pilot Panel 405 functions as an intelligent, contextual guidance interface. The Co-Pilot Panel 405 may provide suggestions related to best practices, offer optimizations inferred by Adherence Checker 306, or preview predicted outcomes as modeled by Intent Refinement Component 305. In some configurations, Co-Pilot Panel 405 may operate asynchronously, presenting side-by-side visualizations of executed commands and proposed alternatives based on historical usage, large language model (LLM)-enhanced design standards, or UI guidelines.

A key validation checkpoint within the subsystem is Object Mapping & Detection 406, which integrates vision-based recognition via a CNN architecture to confirm the system has correctly identified the UI object referenced by a user's voice command. When subsystem Object-to-Token Linking & Intent Resolution 550 resolves the intended target, Object Mapping & Detection 406 receives object reference data, and applies CNN-based visual verification to assess proximity, alignment, dimensions, and UI state before execution proceeds. Object-to-Token Linking & Intent Resolution 550 also incorporates input from Design System Object Lookup 206 to cross-reference the intended object against the known inventory of interface elements.

In some embodiments, Manual Input Device Processing 304 may supplement is Object Mapping & Detection 406 with real-time pointer (e.g., mouse cursor) location, click data, or selection gestures, particularly when the user utilizes a hybrid interaction model. For example, if a user hovers the mouse cursor over a visual element while issuing a command like “Change this to blue,” Object Mapping & Detection 406 leverages the spatial data from Manual Input Device Processing 304 to further validate the object in question.

Once validation completes, object identity and position data are passed downstream to both Graphical Rendering 620 and Interaction Manager 610, ensuring that the rendered action aligns with the AOAV structure and user context. If ambiguity or conflict is detected, such as mismatches between voice interpretation and object targeting, Object Mapping & Detection 406 triggers an error-handling routine via Audio/Visual Feedback 720, prompting a visual cue, modal dialog, or spoken confirmation before execution. The user may then adjust, confirm, or cancel the intended operation.

To support future learning and improve object selection confidence, Object Mapping & Detection 406 may also transmit execution validation data to User Context & Preferences Storage 301, which archives corrections, confirmation events, and manual override decisions. These updates allow reinforcement learning mechanisms in Adaptive Refinement 710 to improve object detection accuracy and command prediction confidence over time. This is particularly applicable to users who experience physical limitations, such as fine motor control where the system can align current intent with successful executions from past sessions.

In this way, the Graphical User Interface Subsystem 400 acts as the tangible execution and verification surface for the entire AOAV interaction model, merging voice input with manual control into a unified and visually interpretable environment. By layering real-time feedback, visual tracking, and CNN-based validation into discrete interface panels, the subsystem ensures that every command issued is traceable, verifiable, and modifiable—transforming traditional static GUI interactions into adaptive, intelligent, and user-centered engagement.

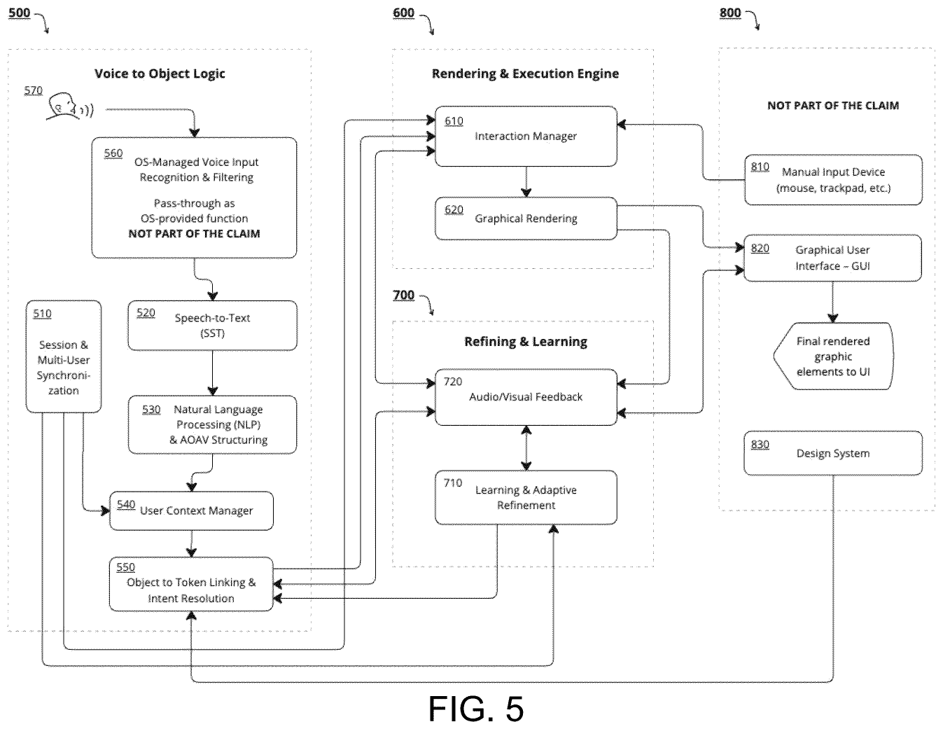

FIG. 5 illustrates a Voice to Object Logic Subsystem 500, Rendering & Execution Engine Subsystem 600, Refining & Learning Subsystem 700, and Host Application Subsystem 800 of the multimodal HCI platform, in accordance with some embodiments. The Voice to Object Logic Subsystem 500 may serve as the initial processing domain in the system, transforming raw speech input into structured, executable commands. In some embodiments, Voice to Object Logic Subsystem 500 captures user vocal input, converts it to text, derives user intent using natural language processing, and structures the command into the AOAV format. The system then links this parsed structure to actionable GUI elements. The Voice to Object Logic Subsystem 500 may further perform contextual disambiguation and role-based adaptation prior to dispatching execution directives downstream.

The process may begin when a user initiates a voice-based interaction, indicated by speech 570. This raw speech signal is routed to OS-Managed Voice Input Recognition & Filtering 560, which, in some embodiments, operates within the host device's native operating system. The signal may undergo pre-processing, such as noise cancellation, gain normalization, and voice isolation, to improve the clarity and consistency of the audio waveform.

Once refined, the processed signal is delivered to STT Processing 520, where an ASR model, that may be based on deep neural networks, translates the audio waveform into transcribed text. The ASR model may include hybrid decoding techniques optimized for command-based sentence structures and may be configured to dynamically adjust recognition parameters based on user role or historical speech patterns retrieved from prior sessions.

The resulting transcribed text is next relayed to Natural Language Processing & AOAV Structuring 530, where a sequence of linguistic interpretation processes may be applied. These may include: tokenization of words and phrases, dependency parsing to determine syntactic relationships between tokens, NER to identify software-specific objects (e.g., “toolbar,” “header,” “rectangle”), and AOAV Structuring, wherein the system dynamically reformats the sentence into a standardized four-part representation: Action, Object, Attribute, and Variable.

Upon AOAV structuring, the system evaluates whether the structured command includes any ambiguous object references. If an ambiguity is identified, the command is routed to User Context Manager 540, which retrieves user-specific interaction history, role-based permissions, and recent UI selections from Session & Multi-User Synchronization 510 and User Context & Preferences Storage 301. The system may compare the current utterance with previous commands to infer the intended object when pronouns or implicit references (e.g., “that one”, “make it larger”) are used. In some embodiments, User Context Manager 540 may coordinate with Object Mapping & Detection 406 to visually verify whether the selected object on screen corresponds to the intended object parsed from the user's speech.

Once context is established, the structured AOAV token stream is passed to Object-to-Token Linking & Intent Resolution 550. At this stage, the system identifies the appropriate UI element to associate with the structured command, using application-specific design references supplied by Design System 830 and validated against current application state. If more than one object qualifies as a match, or if intent confidence is below a defined threshold, the system may trigger Audio/Visual Feedback 720 to request clarification from the user, such as “Did you mean the top-right rectangle or the red circle?”

Parallel to this resolution path, Intent Resolution 550 receives reinforcement from Learning & Adaptive Refinement 710, which continuously updates AOAV parsing models based on prior successful or corrected executions. In cases where the execution mapping is clear and confirmed, Intent Resolution 550 passes the fully linked, validated AOAV command to Interaction Manager 610 in the Rendering & Execution Engine Subsystem 600 for downstream integration.

In collaborative environments, Session & Multi-User Synchronization 510 plays an essential role in adapting Voice to Object Logic Subsystem 500 to multi-user workflows. This includes determining whether the command applies globally or locally, enforcing role-based execution rights, and synchronizing AOAV preference models across multiple users. For instance, an administrator's command to “lock this panel” may override local edits by editor-level users, triggering Intent Resolution 209.

Voice to Object Logic Subsystem 500 also serves as a primary contributor to user personalization and execution refinement. Based on accumulated behavioral data and role-based access control models, commands are dynamically adapted for accuracy and relevance. Over time, User Context Manager 540 may shift AOAV structuring parameters and command confidence thresholds to suit individual speech styles, accents, world languages, or application usage patterns, enhancing system responsiveness and reducing reliance on manual confirmation.

In sum, Voice to Object Logic Subsystem 500 provides the essential transformation layer between natural human speech and precise system execution. Through multi-stage linguistic processing, contextual modeling, and role-aware refinement, Voice to Object Logic Subsystem 500 ensures that user voice commands are faithfully interpreted, disambiguated, and prepared for accurate graphical execution within the user interface.

The Rendering & Execution Engine Subsystem 600, in some embodiments, may perform the core function of translating resolved AOAV-based intent into actual system execution, coordinating graphical modifications, managing command prioritization, and ensuring visual alignment of the host interface with the interpreted user intent. Rendering & Execution Engine Subsystem 600 serves as the final processing and execution pipeline wherein AOAV-structured commands, once disambiguated and validated, are prioritized, routed, and converted into concrete visual and behavioral updates within the host software environment.

Upon successful intent resolution by Object-to-Token Linking & Intent Resolution 550, an AOAV-formatted execution command may be transferred to Interaction Manager 610. Within this component, execution requests are organized for priority evaluation and conflict resolution through its internal process handler, Interaction Integrator 302. Here, Rendering & Execution Engine Subsystem 600 evaluates command concurrency—specifically whether incoming AOAV instructions should supersede or defer to manual inputs received from a Manual Input Device 810 (e.g., mouse, keyboard, touchscreen) via Manual Input Device Processing 304.

In some embodiments, execution commands determined to have high-confidence association with specific UI elements, as validated by User Context Manager 540 and Object Mapping & Detection 406, may be passed immediately to Execution Manager 303. This internal component may utilize an ELEM to queue and dispatch commands in strict sequential or dependency-based order. Structured AOAV actions (e.g., “Resize rectangle to 900 px by 600 px”) are re-encoded into host-application-compatible API calls or rendering operations and issued accordingly.

Once scheduled for execution, visual updates may be rendered by Graphical Rendering 620, which modifies the graphical state of the GUI in real time. Before the final rendering occurs, Graphical Rendering 620 may engage in a verification step that references Design System 830 and Design System Object Lookup 206 to ensure conformance with system-defined design constraints, reusable component rules, and object attribute specifications. Concurrently, Object Mapping & Detection 406 may be invoked to validate the object selection visually, ensuring that the command targets the correct UI entity before graphical rendering is committed.

If the interaction includes ambiguity, multiple overlapping commands, or results in execution conflicts, such as attempting to modify an already-modified UI element, Intent Refinement Component 305 and Adherence Checker 306 may be triggered. These components analyze the command structure and compare it to known patterns, system heuristics, and learned best practices from previous user sessions. In the event that a conflict is detected, the system may engage Audio/Visual Feedback 720 to provide a clarification prompt, propose a corrected command, or allow the user to disambiguate or cancel the execution pathway.

If no conflict is identified and the rendering proceeds, the visual update is directed to GUI 820 for final presentation. This ensures the visible state of the application interface remains consistent with the user's spoken intent and the underlying AOAV command structure.

In parallel, the system logs all successful execution outcomes into User Context & Preferences Storage 301, enabling retention of interaction history and reinforcing frequently used AOAV structures. This behavioral data may be forwarded to Learning & Adaptive Refinement 710, where it is processed by Reinforcement Learning 208 to improve future parsing accuracy, command confidence scoring, and disambiguation strategies based on user-specific interaction profiles.

Rendering & Execution Engine Subsystem 600 may therefore serve as the dynamic interface layer between intent and execution, integrating adaptive learning, object validation, input prioritization, and rendering consistency into a unified execution flow. By ensuring that AOAV-based commands result in accurate, visually confirmed modifications to the host interface, the Rendering & Execution Engine Subsystem 600 transforms user speech and manual input into an efficient, adaptive, and contextually responsive command execution environment.

The Refining & Learning Subsystem 700 may function as the core adaptive intelligence module responsible for continuously improving the accuracy, clarity, and contextual adaptability of AOAV-structured command execution. The Refining & Learning Subsystem 700 analyzes user interactions in real time, leveraging reinforcement learning and execution confidence scoring to refine future command parsing, prioritization, and resolution. The Refining & Learning Subsystem 700 comprises two primary components: Learning & Adaptive Refinement 710 and Audio/Visual Feedback 720.

Execution activity typically begins upstream in Object-to-Token Linking & Intent Resolution 550, which routes finalized AOAV intent to downstream execution components in the Rendering & Execution Engine Subsystem 600. Once an execution pathway is triggered, Refining & Learning Subsystem 700 begins a dual refinement cycle, which includes intelligently improving system behavior through Learning & Adaptive Refinement 710 while providing real-time interaction feedback via Audio/Visual Feedback 720.

The Learning & Adaptive Refinement 710, in some embodiments, may apply PPO via internal module Reinforcement Learning 208, analyzing successful and failed executions stored in User Context & Preferences Storage 301. These patterns are evaluated for behavioral consistency, action-object mapping accuracy, and AOAV structuring efficiency. Where refinements are indicated, Learning & Adaptive Refinement 710 may route adaptive parameters to User Context Manager 540 for integration into contextual awareness logic, including Intent Recognition 204, NER 205, and Design System Object Lookup 206.

To further increase predictive accuracy, Intent Refinement Component 305 may be invoked to generate higher-confidence alternatives to ambiguous or complex user commands. Before any learning-based change is committed, Adherence Checker 306 ensures that refinements comply with expected execution behaviors, constraints, and system policies. If validated, these refinements are propagated downstream to Intent Resolution 550, where object-token linking strategies are updated, and to Interaction Manager 610, where execution prioritization behavior is refined through Interaction Integrator 302.

Simultaneously, the Audio/Visual Feedback 720 ensures that the user receives clear, immediate confirmation of execution results, including success messages, warnings, or clarification prompts. Feedback may be visual, displayed in Voice Command Display Panel 402 of the GUI 820, or auditory, synthesized via Audio Output 207. If execution confidence is below a system-defined threshold, Audio/Visual Feedback 720 may engage Intent Refinement Component 305 and Adherence Checker 306 to assess whether a clarification prompt should be issued, alerting the user to confirm or reject the intended action.

Audio/Visual Feedback 720 further integrates input from Object Mapping & Detection 406 to verify that voice-referenced objects align with visually selected UI elements. If misalignment is detected, the system halts execution and prompts user confirmation through Audio/Visual Feedback 720. All feedback interactions are logged into User Context & Preferences Storage 301, closing the feedback loop and enabling learning refinement in future sessions.

Finally, Refining & Learning Subsystem 700 ensures that multi-user scenarios are accounted for by accepting user role profiles and synchronization data from Session & Multi-User Synchronization 510, processed in Multi-User Context Synchronization 103. Learning refinements may be applied across shared environments without compromising user-specific behavior, ensuring consistent AOAV interpretation and command resolution in collaborative settings.

By integrating reinforcement learning, execution validation, error correction, and real-time user feedback, Refining & Learning Subsystem 700 plays a critical role in transforming raw execution outcomes into adaptive behavioral intelligence, making every interaction more accurate, consistent, and user-specific over time.

The Host Application Subsystem 800 serves as the final destination for both AOAV-driven command execution and traditional user interaction, managing the integration, presentation, and visual rendering of executed actions within the live software environment. Host Application Subsystem 800 enables the delivery of dynamic, multi-modal interaction experiences by coordinating manual input, GUI display, and structured design components drawn from the application's internal repository.

Host Application Subsystem 800 comprises three key components: Manual Input Device 810, GUI 820, and Design System 830.

The Manual Input Device 810 represents standard user-controlled peripherals such as a mouse, trackpad, keyboard, or touchscreen. These devices operate outside the AOAV pipeline and feed raw spatial data, such as cursor position, click events, and scrolling, directly into the host environment. This input allows users to select objects, adjust views, or issue contextual positioning cues that are later reconciled with AOAV-driven execution workflows by Interaction Manager 610 through Interaction Integrator 302.

The GUI 820 is the primary canvas upon which executed AOAV commands are visually represented. The GUI 820 receives input from a range of upstream components. Graphical Rendering 620 delivers graphical modifications to active UI objects, while Object-to-Token Linking & Intent Resolution 550 supplies object-verified AOAV instructions for execution. Audio/Visual Feedback 720 communicates error-handling overlays or execution confirmation prompts when necessary. Manual Input Device 810 contributes user-driven input for traditional interaction, and Design System 830 provides structured graphical objects available for rendering and manipulation. Within GUI 820, internal components may be responsible for hosting visual content, displaying command logs, managing the canvas, generating best-practice suggestions, and validating object selection accuracy.

Upon receipt of a valid AOAV-driven instruction, GUI 820 visually updates the Design Area Canvas 404 to reflect the user command. If the user, for example, issues the command, “Add a 40 px button,” and that command is successfully resolved by Voice to Object Logic Subsystem 500 and validated through Rendering & Execution Engine Subsystem 600, GUI 820 updates the canvas with a rendered instance of the corresponding object from the Design System 830 repository. The Voice Command Display Panel 402 confirms the spoken command was parsed and accepted, while System Execution History Panel 403 logs the interaction for subsequent review and learning. Should the system detect an error, Object Mapping & Detection 406 validates object alignment, and Co-Pilot Panel 405 may offer improved command alternatives.

The Design System 830 functions as a static repository containing structured graphic objects, templates, and reusable UI components. While it performs no active processing itself, it plays a vital role in enabling AOAV-driven instantiations by responding to requests from upstream components such as Intent Resolution 550, User Context Manager 540, and Interaction Manager 610. When a user issues a command, such as “Insert a navigation bar,” the request is mapped by Intent Resolution 550 and dispatched to Design System 830, which retrieves the corresponding object definition. These objects are then rendered via Graphical Rendering 620 and visually displayed in GUI 820.

Design System 830 may have content that is indexed and queryable by name, function, and context, allowing structured object retrieval. User Context Manager 540 may adapt these retrievals based on user preferences stored in User Context & Preferences Storage 301, ensuring that personalized object variants are served. Execution confirmation and alignment with UI context is verified through Object Mapping & Detection 406, while execution success is signaled via Audio/Visual Feedback 720, with feedback optionally delivered in visual form by Voice Command Display Panel 402 and audio form via Audio Output 207 if enabled by the user.

In some embodiments, if an execution action involving a design object is ambiguous or maps to multiple variants, the system may invoke Intent Refinement Component 305 to propose likely interpretations and use Adherence Checker 306 to validate that execution remains within allowable design boundaries. If ambiguity persists, Audio/Visual Feedback 720 prompts the user for clarification before proceeding with rendering in GUI 820.

By unifying manual control from Manual Input Device 810, real-time AOAV rendering via GUI 820, and access to structured graphical content of the Design System 830, the Host Application Subsystem 800 ensures a seamless and intuitive user experience.

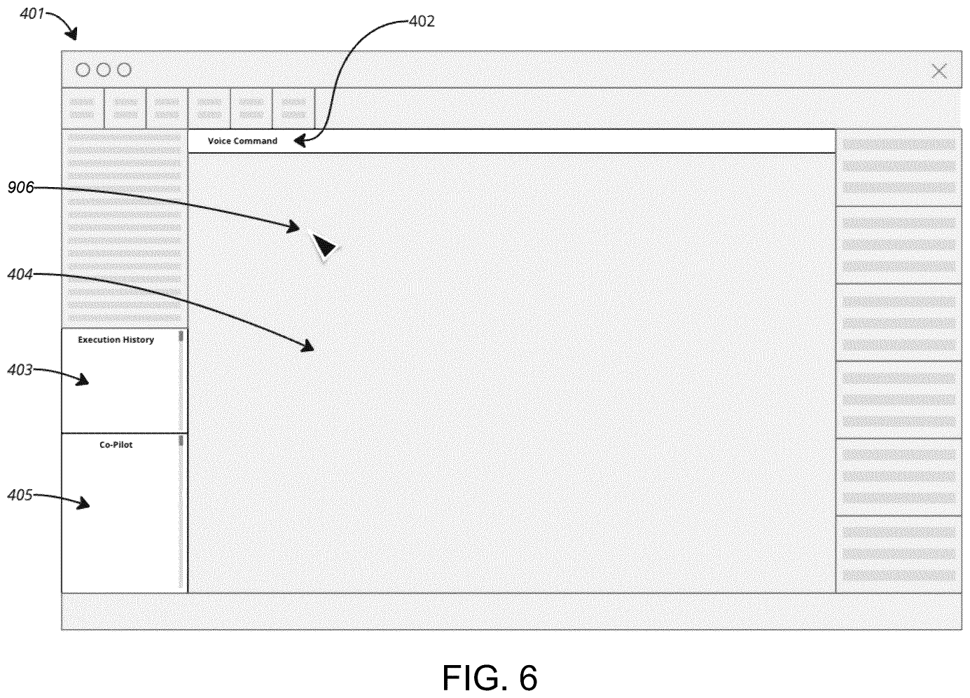

FIGS. 6-12 illustrate an example user interaction with a GUI 820 utilizing the multimodal HCI platform, in accordance with some embodiments. FIG. 6 illustrates an example of a Main UI Layer 401 in a GUI 820 used for graphic design. FIG. 6 illustrates components of the interface including the mouse cursor 906 and Design Area Canvas 404. Elements added into the user interface which could either be instantiated into the UI as shown or as auxiliary “floating” windows include the Voice Command Display Panel 402 which provides the user with feedback from the Refining & Learning Subsystem 700, the System Execution History Panel 403 which displays a running log of the commands executed by the system, and the Co-Pilot Panel 405 which provides the user with real-time suggestions for improved designs (e.g., WCAG best practices for digital product accessibility).

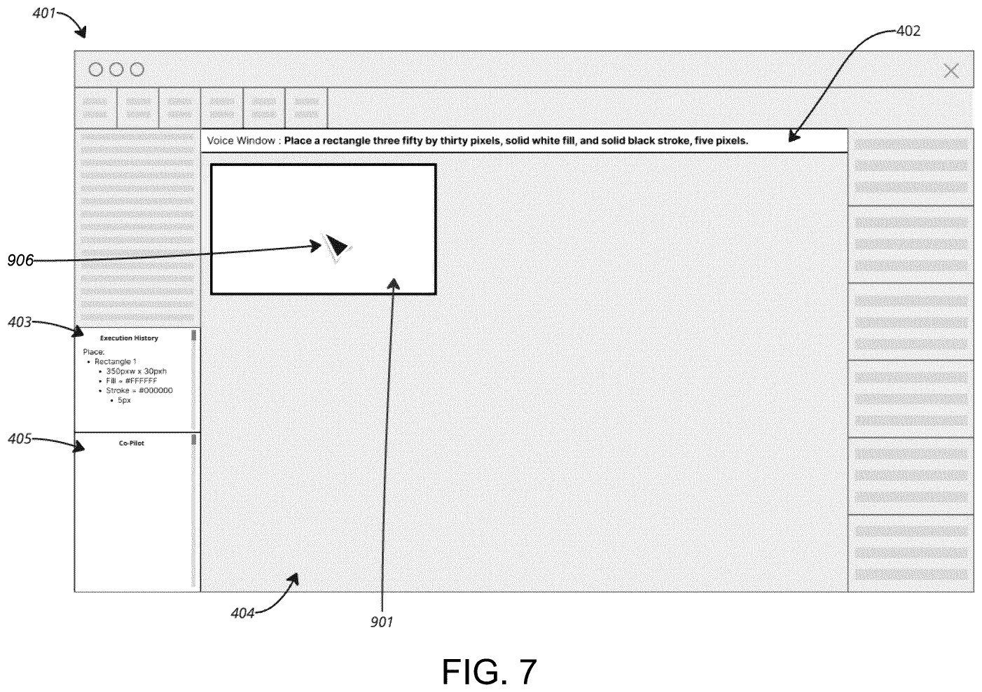

FIG. 7 illustrates receiving a first vocal command: “Place a rectangle three fifty by two hundred pixels, solid white fill, and solid black stroke, five pixels.” The Voice Command Display Panel 402 displays the natural language it understands from the user. The system responds by placing the white rectangle 901 centered on and beneath the mouse cursor 906. The System Execution History Panel 403 displays the command structure it understands through the user sentiment and intent processing of the Intent Recognition 204 represented in the ontological structure of AOAV with most recent command at the top line. This is the data passed onto the host application to execute the commands.

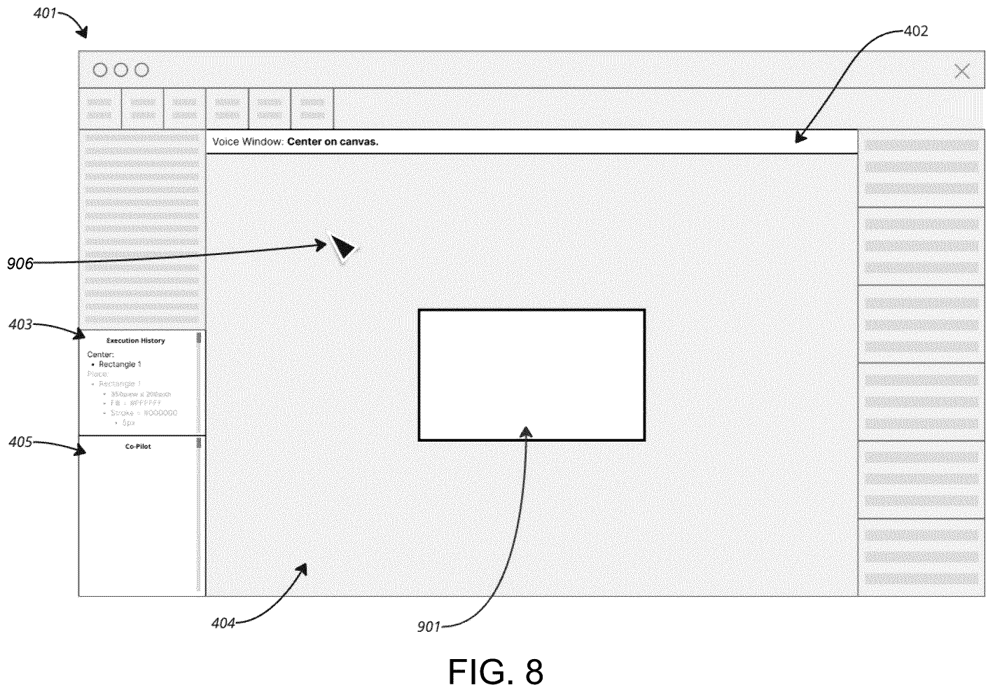

FIG. 8 illustrates receiving a second vocal command: “Center it on canvas” which is displayed in the Voice Command Display Panel 402 for visual feedback. Because the last action was to instantiate a rectangle, the system retains that context of which object is being referred to by “it” and relocates the rectangle 901 to the center of the Design Area Canvas 404 without the object needing to be selected by a manual input, such as a mouse. The System Execution History Panel 403 is updated to show the new placement of the object by adding the command to the top of the running list.

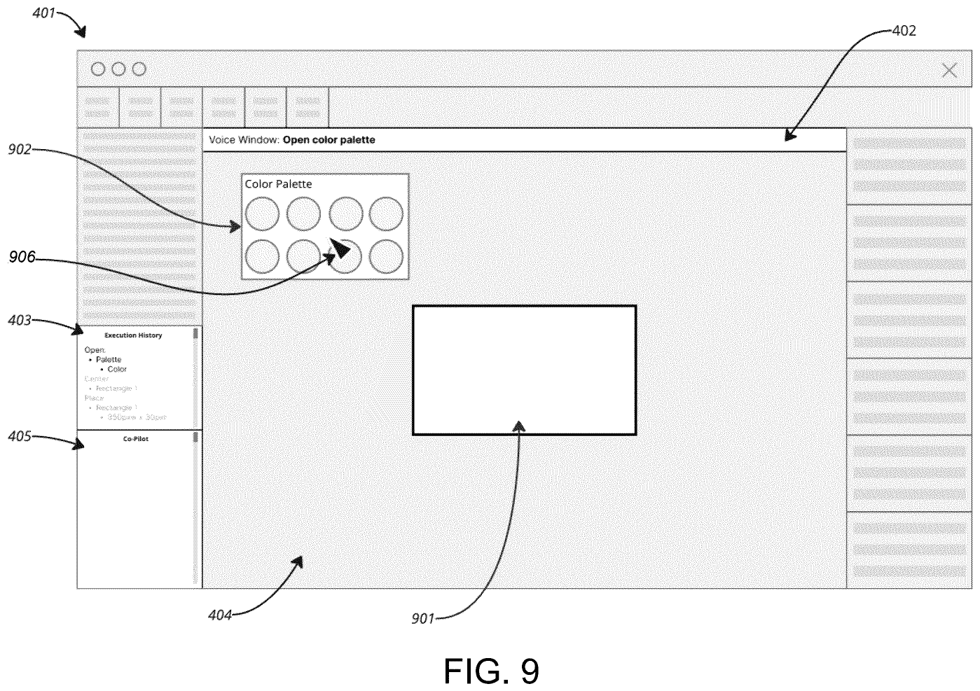

FIG. 9 illustrates receiving a third vocal command: “Open color palette” which is recognized from Design System Object Lookup 206 and displays the command in the Voice Command Display Panel 402 for confirmation. The system responds by bringing forth the Color Palette 902 that otherwise would have taken several mouse clicks to access. In this case, the Color Palette 902 is rendered directly underneath and centered on the mouse cursor 906. The System Execution History Panel 403 is updated to show the accessing of the Color Palette 902.

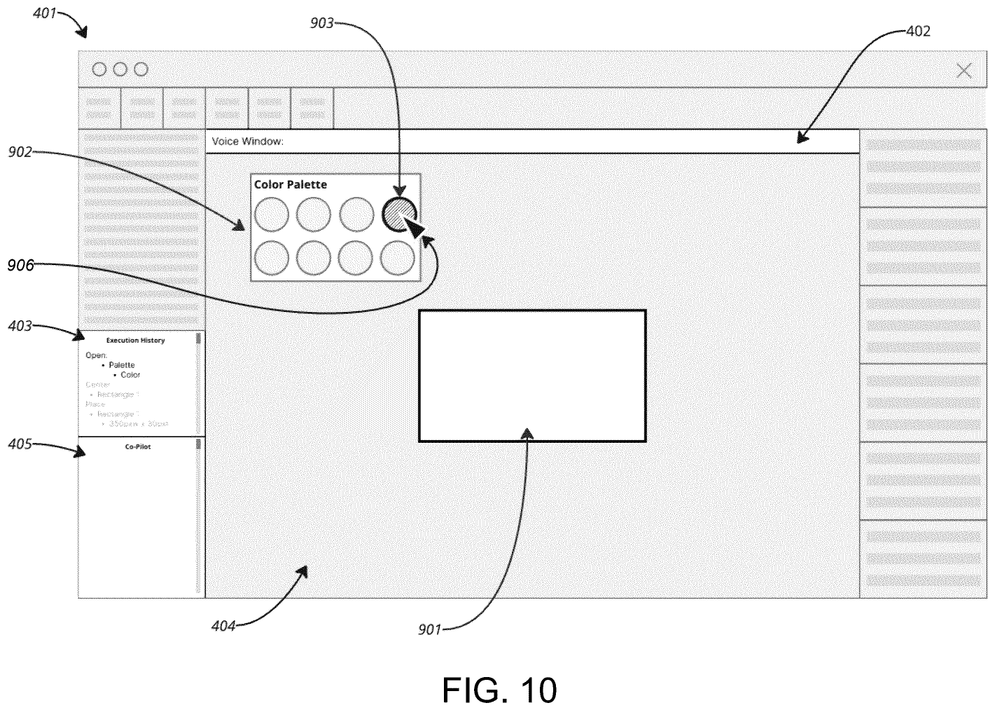

FIG. 10 illustrates a manual input of the mouse to move the mouse cursor 906 over the color token 903 on the Color Palette 902. With this mouse hover, the color token 903 visually indicates “soft-selection” by its pre-programmed “hover state” as a built-in function of the host application. Nothing else happens with the system at this point other than the object being “soft-selected” by means of the mouse cursor 906 hovering over the color token 903. The command is displayed in the Voice Command Display Panel 402 for real-time confirmation and the System Execution History Panel 403 adds the executed command to it's running list.

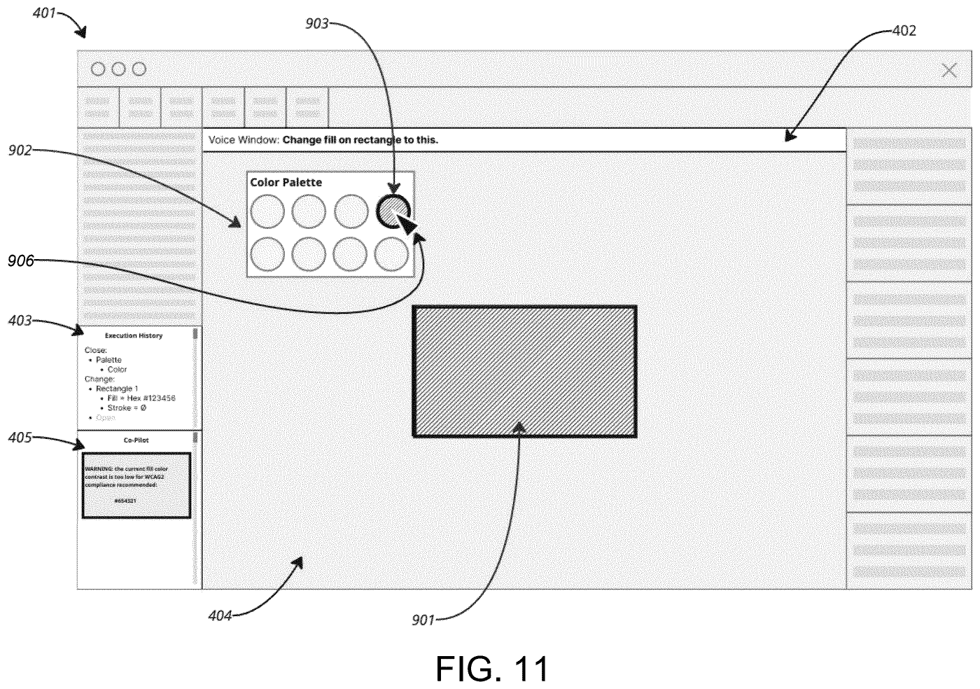

FIG. 11 illustrates the mouse cursor 906 hovering over the color token 903 on the Color Palette 902 and receiving a fourth vocal command: “Change fill of the rectangle to this.” Through the anaphoric nature of the NLP's continuous context the user's command is tokenized: “change”=Action; “the rectangle”=Object; “fill”=Attribute; “this” mouse-selected color=Variable. The Object Mapping & Detection 406 confirms the color token 903 under the mouse cursor 906 is a valid object that satisfies the intent. The system then sends a command to the host application to update the rectangle object 901 to the color fill specification of color token 903. The command is displayed in the Voice Command Display Panel 402 for real-time confirmation and the System Execution History Panel 403 adds the executed command to it's running list.

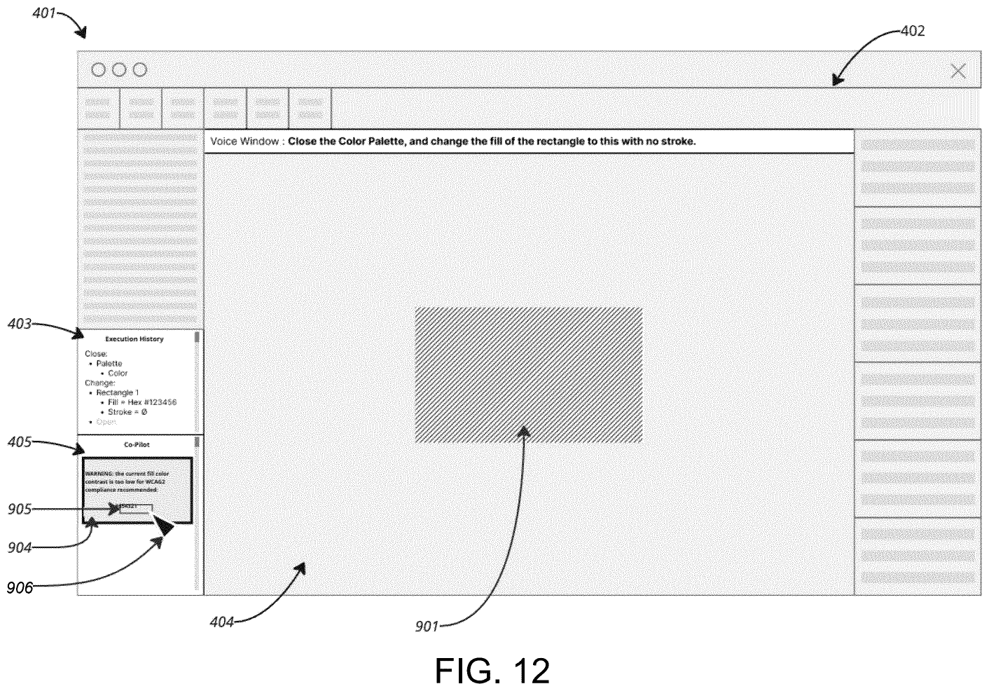

FIG. 12 illustrates the Co-Pilot Panel 405 displaying an alert 904 to the user that the selected color (e.g., color token 903) does not support accessibility standards for contrast and recommends a satisfactory color as a hex value 905. The user may notice this recommendation and elect to update the rectangle's fill color to the recommended value (e.g., hex value 905), which may be highlighted to indicate it is an interactive element. The user manually locates the mouse cursor 906 over the recommended color specification hex value 905 indicated in the Co-Pilot Window 405 and utters a fifth vocal command: “Close the Color Palette, and change the fill of the rectangle to this with no stroke.” The Voice Command Display Panel 402 displays the statement as the system understands it. By means of the Intent Recognition 204, the system recognizes that “this” refers to the object which is currently pre-selected by the active hover state triggered by the mouse cursor 906 (e.g., hex value 905). The system responds by closing the Color Palette 902, changing the fill color of the rectangle 901 to the color specified by the mouse cursor 906 (e.g., hex value 905 “hex #654321”), removes the rectangle's 901 stroke, and updates the System Execution History Panel 403.

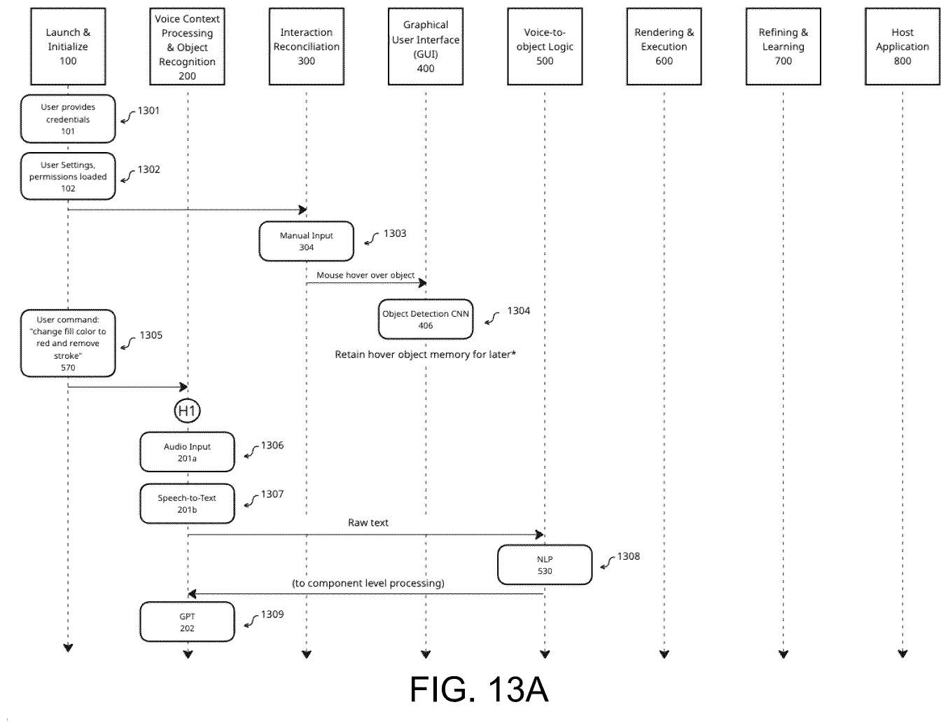

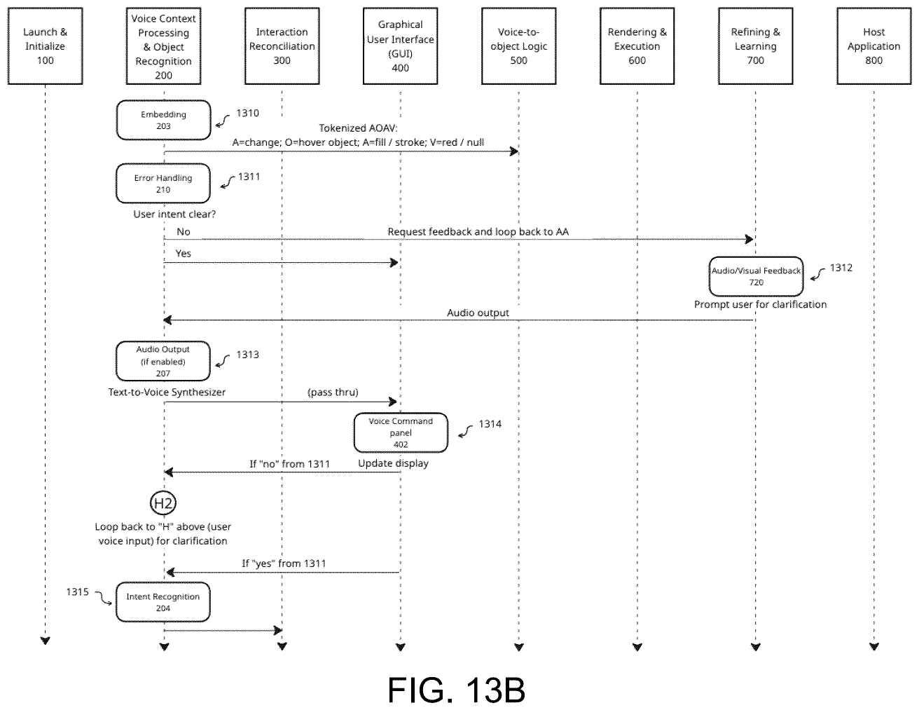

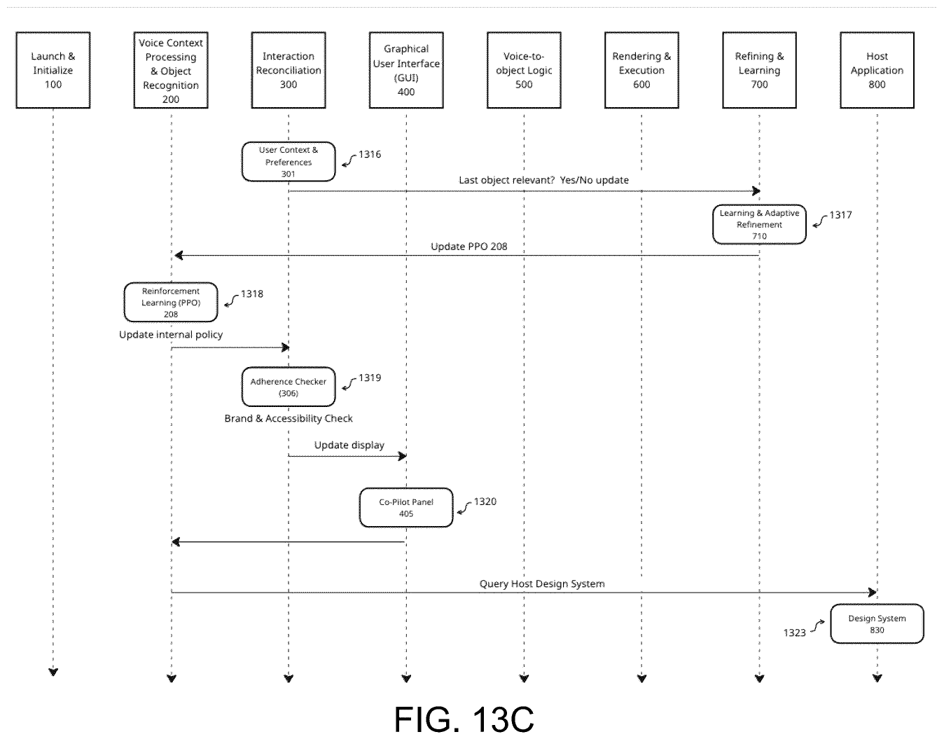

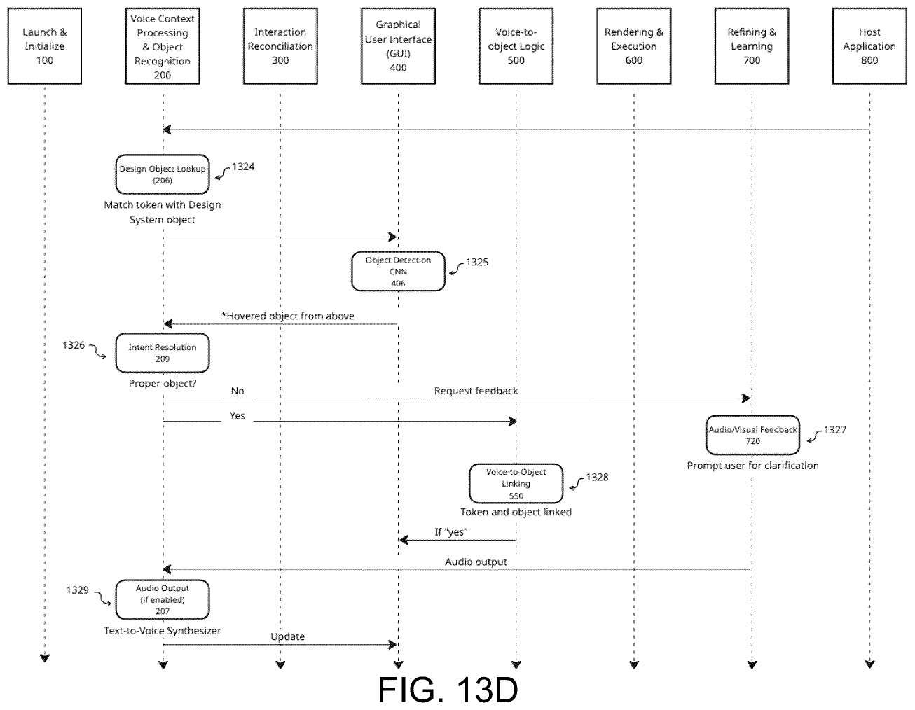

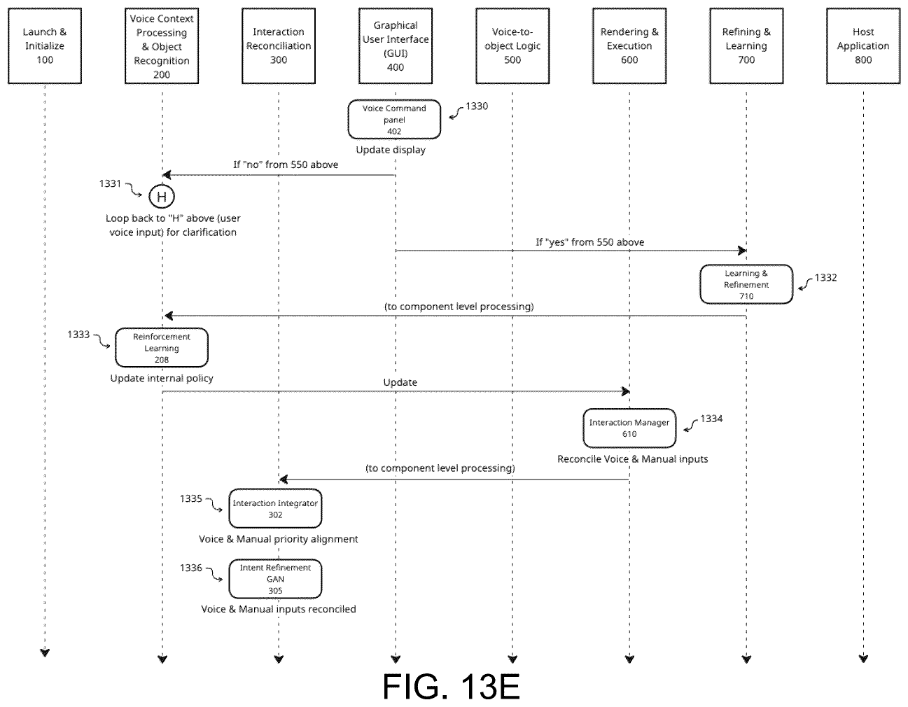

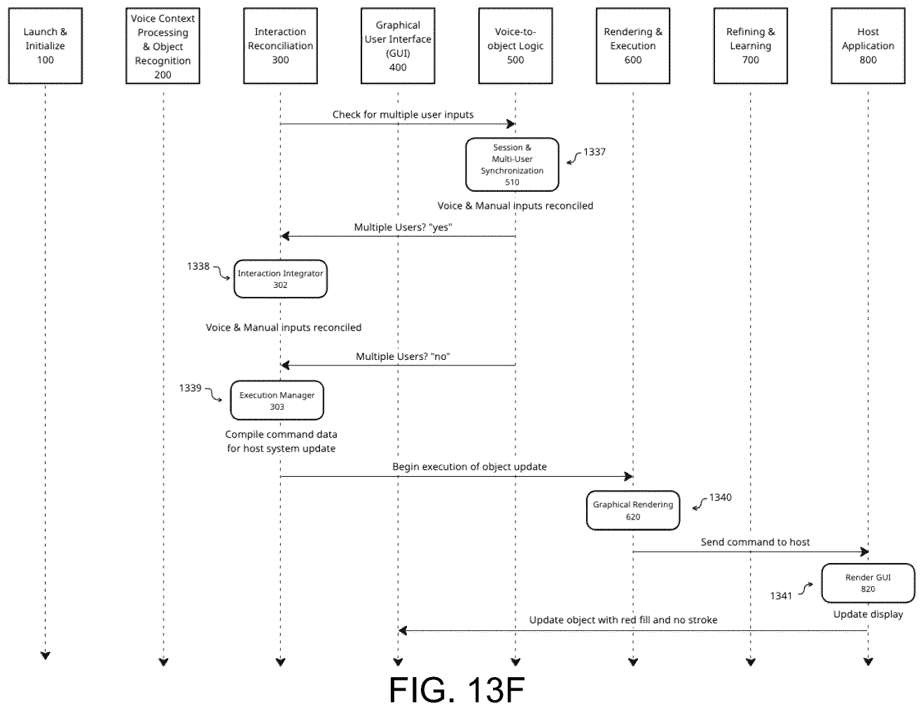

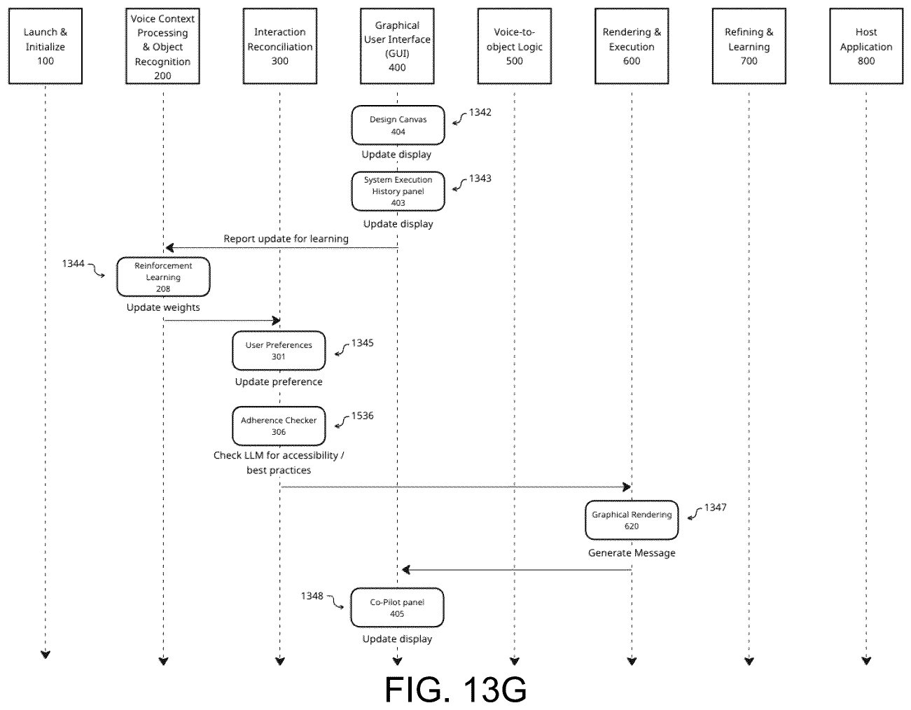

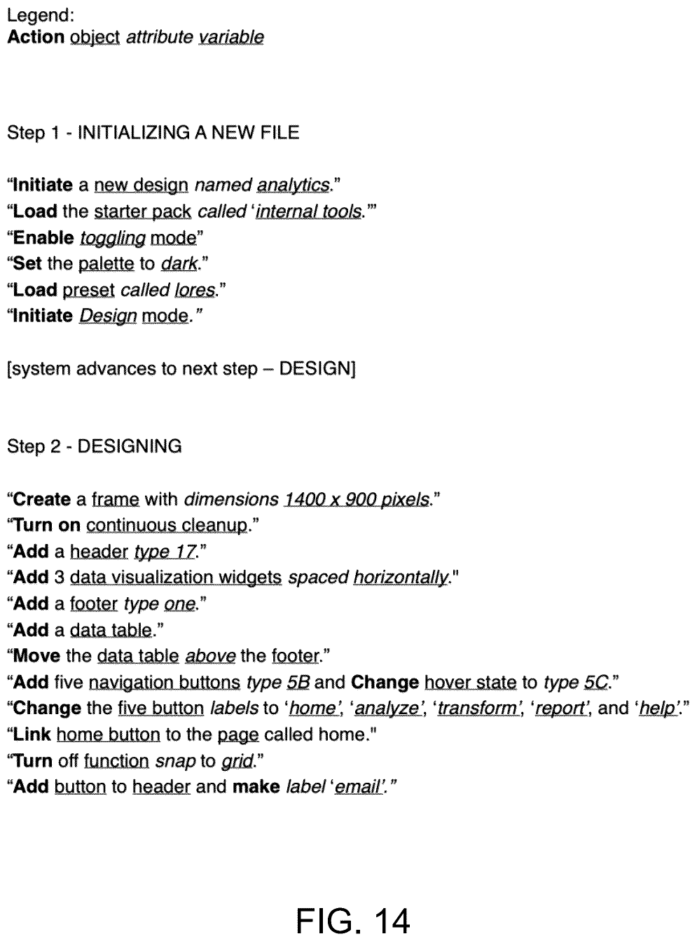

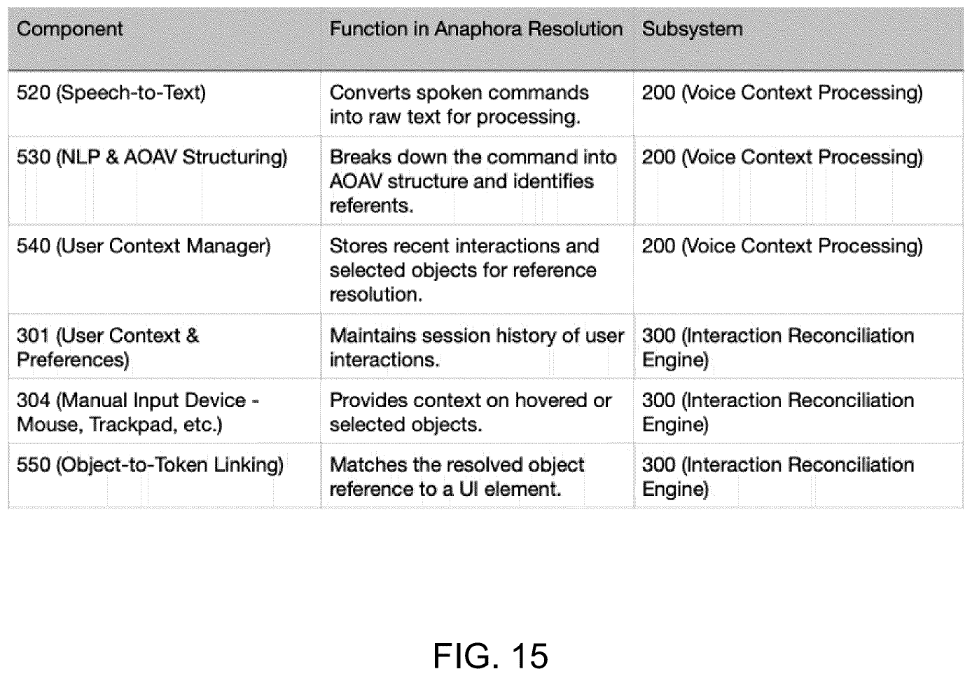

FIGS. 13A-13G illustrate cross-functional flow diagram of an integrated voice and mouse interaction using the multimodal HCI platform, in accordance with some embodiments. This sequence illustrates the end-to-end system behavior during a typical multimodal interaction involving both voice and manual input. In this example, a user hovers the mouse cursor over a rectangular object and then issues a spoken command: “Change the fill color to red and remove stroke.” The system executes this request, coordinating the manual and voice inputs with other users if occurring in a multi-user session, and concludes with learning updates, adherence validation, and Co-Pilot assistance.

At operation 1301, the user begins the interaction by providing authentication credentials, which are verified by the Authentication & Login Processing 101 within the Launch & Initialize Subsystem 100. Upon successful authentication, at operation 1302, the system retrieves user-specific execution settings, role permissions, and any previously stored design context through Session Initialization & User Profile Loading 102, completing the session launch process. At operation 1303, the user then moves the mouse cursor over a rectangular object on the screen, and this manual input is detected by the Manual Input Device Processing 304. At operation 1304, the hovered object is validated for recognition and selection accuracy using Object Mapping & Detection 406, which leverages a CNN for object verification.

After visually identifying the object, at operation 1305, the user speaks the command “Change the fill color to red and remove stroke.” At operation 1306, this spoken command is captured by the Audio Input Processor 201a, which performs signal enhancement and passes the processed audio onward. At operation 1307, the enhanced audio is transcribed into structured text by the Automatic Speech Recognition engine 201b, which applies deep learning-based transcription.

At operation 1308, the transcribed command is passed to the Natural Language Processing and AOAV Structuring component 530, where intent extraction and structuring begin. At operation 1309, the structured text is processed through a pruned GPT model as part of Natural Language Processing 202, which generates initial semantic structure for the spoken command. At operation 1310, the output is further refined by Embedding & Semantic Understanding 203, which produces a complete AOAV structure: Action=“change,” Object=“rectangle,” At-tribute=“fill color” and “stroke,” and Variable=“red” and “remove”. At operation 1311, the system evaluates the confidence score of this AOAV command using Error Handling 210, which determines if additional user confirmation is required. If the confidence is below threshold, at operation 1312, a clarification request is generated by Audio/Visual Feedback 720, prompting the user for confirmation or correction. If voice feedback is enabled, at operation 1313, the system converts the clarification message into speech via Audio Output 207, delivering the prompt to the user. At operation 1314, the system also displays the same clarification prompt visually through the Voice Command Display Panel 402, allowing the user to review the interpreted command.

If confidence is sufficient, or once clarification is received, at operation 1315, the command proceeds to Intent Recognition 204, which identifies the command operation as a shape style modification. Simultaneously, at operation 1316, the system checks User Context & Preferences Storage 301 for recent interactions and user-specific styling preferences to refine command intent.

At operation 1317, this contextual data is passed into the Learning & Adaptive Refinement 710 to inform dynamic execution tuning. At operation 1318, the system applies Reinforcement Learning 208 to update its internal decision policies based on user behavior. At operation 1319, the AOAV command is checked for consistency with design rules and best practices using the Adherence Checker 306, which references domain-specific constraints. If discrepancies are detected, at operation 1320, a visual warning is displayed through the Co-Pilot Panel 405, providing a real-time suggestion or accessibility alert.

At operation 1323, to validate the object being modified, the system queries the Design System 830 within the host application to retrieve structural metadata. At operation 1324, this retrieval is handled by Design System Object Lookup 206, which accesses a repository of predefined UI elements. At operation 1325, the retrieved design reference is compared with real-time visual data from Object Mapping & Detection 406 to confirm the selected object.

At operation 1326, Intent Resolution 209 then determines whether the object selected by the user and the object referenced in the AOAV command are the same. If there is a mismatch, at operation 1327, the system loops back to the Audio/Visual Feedback 720 to request user clarification through Audio Output 207 and Voice Command Display Panel 402. If the object match is confirmed, at operation 1328, the command is routed through the Object-to-Token Linking & Intent Resolution 550, preparing it for execution.

At operation 1329, a confirmation message such as “Do you want to change this rectangle's fill to red and remove the stroke?” is generated by Audio Output 207 if the user has enabled voice-synthesized audio feedback. At operation 1330, this clarification-seeking message is passed through Audio Output 207 and also displayed in the Voice Command Display Panel 402 for user review before final execution. If the user does not confirm or correct the instruction, at operation 1331, the system loops back to reinitiate parsing beginning at operation 1306.

Once the command is validated, at operation 1332, the Learning & Adaptive Refinement 710 is updated with the outcome of this decision. At operation 1333, Reinforcement Learning 208 adjusts internal model weights and prediction behavior based on the confirmed success of the interaction. At operation 1334, the Interaction Manager 610 initiates execution by merging voice-driven intent with the manual object selection. At operation 1335, this coordination occurs in the Interaction Integrator 302, which resolves input priority and execution flow. At operation 1336, the Intent Refinement 305 may combine the “fill color=red” and “remove stroke” commands into a unified, atomic action.

In multi-user scenarios, at operation 1337, the Session & Multi-User Synchronization 510 resolves any role-based execution conflicts. At operation 1338, the integrated execution logic is passed back to Interaction Integrator 302, where final validation occurs.

At operation 1339, the command is executed by Execution Manager 303, which generates the metadata which will be sent for rendering. At operation 1340, Graphical Rendering 620 processes the visual update and prepares the object for GUI 820 display. At operation 1341, the rendered object is passed to the GUI 820 within the host application for display. At operation 1342, the change becomes visible in the Design Canvas 404, where the rectangle's fill turns red and its stroke is removed.

At operation 1343, this executed command is logged in the System Execution History Panel 403 as “Changed fill color to red, removed stroke”. At operation 1344, the Reinforcement Learning 208 revalidates this execution, reinforcing its confidence in this user behavior pattern. At operation 1345, the outcome is saved to User Context & Preferences Storage 301, where “no stroke” may now be treated as a default preference.

As a final step, at operation 1346, the Adherence Checker 306 re-evaluates the result for compliance with design or accessibility standards. If the current styling is flagged as potentially problematic, at operation 1347, Graphical Rendering 620 generates a correction alert. At operation 1348, the Co-Pilot Panel 405 then displays a message such as “Add stroke for better con-trast?” prompting user intervention or acceptance.

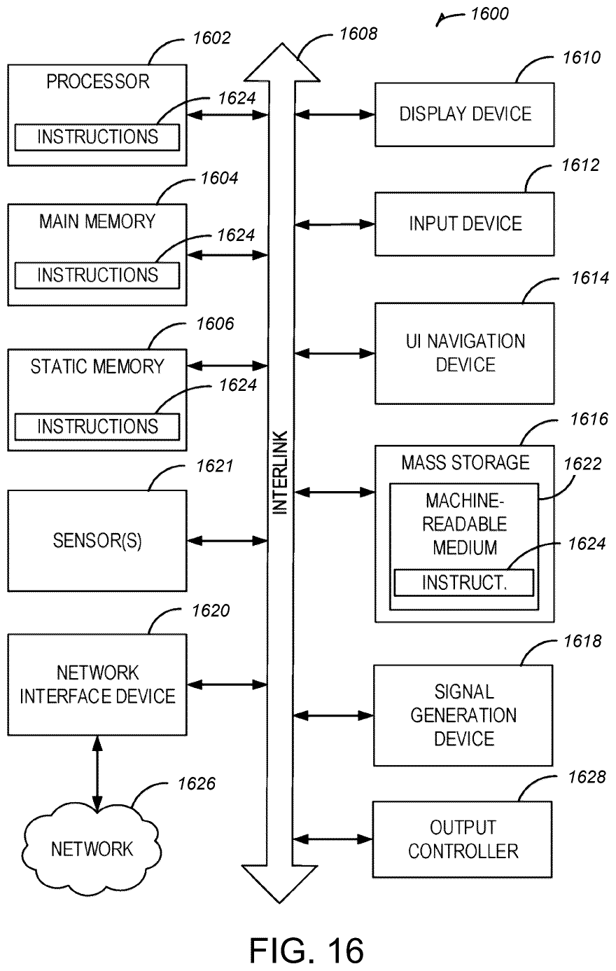

FIG. 16 illustrates a block diagram of an example machine 1600 upon which any one or more of the techniques (e.g., methodologies) discussed herein may perform. In alternative embodiments, the machine 1600 may operate as a standalone device or may be connected (e.g., networked) to other machines. In a networked deployment, the machine 1600 may operate in the capacity of a server machine, a client machine, or both in server-client network environments. In an example, the machine 1600 may act as a peer machine in peer-to-peer (P2P) (or other distributed) network environment. The machine 1600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 1600 may include a hardware processor 1602 (e.g., a central processing unit (CPU), a graphics processing unit (GPU), a hardware processor core, or any combination thereof), a main memory 1604 and a static memory 1606, some or all of which may communicate with each other via an interlink (e.g., bus) 1608. The machine 1600 may further include a display unit 1610, an alphanumeric input device 1612 (e.g., a keyboard), and a user interface (UI) navigation device 1614 (e.g., a mouse). In an example, the display unit 1610, input device 1612 and UI navigation device 1614 may be a touch screen display. The machine 1600 may additionally include a storage device (e.g., drive unit) 1616, a signal generation device 1618 (e.g., a speaker), a network interface device 1620, and one or more sensors 1621, such as a global positioning system (GPS) sensor, compass, accelerometer, or other sensor. The machine 1600 may include an output controller 1628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1616 may include a machine readable medium 1622 on which is stored one or more sets of data structures or instructions 1624 (e.g., software) embodying or utilized by any one or more of the techniques or functions described herein. The instructions 1624 may also reside, completely or at least partially, within the main memory 1604, within static memory 1606, or within the hardware processor 1602 during execution thereof by the machine 1600. In an example, one or any combination of the hardware processor 1602, the main memory 1604, the static memory 1606, or the storage device 1616 may constitute machine readable media.

While the machine readable medium 1622 is illustrated as a single medium, the term “machine readable medium” may include a single medium or multiple media (e.g., a centralized or distributed database, and/or associated caches and servers) configured to store the one or more instructions 1624.

The term “machine readable medium” may include any medium that is capable of storing, encoding, or carrying instructions for execution by the machine 1600 and that cause the machine 1600 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1624 may further be transmitted or received over a communications network 1626 using a transmission medium via the network interface device 1620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1620 may include one or more physical jacks (e.g., Ethernet, coaxial, or phone jacks) or one or more antennas to connect to the communications network 1626. In an example, the network interface device 1620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1600, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A computer-implemented method for integrating voice commands with a graphical user interface (GUI), comprising:
receiving first audio data representing a first natural-language spoken voice command from a user;
processing the first audio data to determine first textual data representing the first natural-language spoken voice command;
determining the first textual data represents a first action of the GUI, wherein determining the first action includes determining a first Action-Object-Attribute-Variable (AOAV) command representing the first textual data in AOAV command format;
executing the first AOAV command to cause the GUI to perform the first action;
receiving second audio data representing a second natural-language spoken voice command from the user;
processing the second audio data to determine second textual data representing the second natural-language spoken voice command;
determining the second textual data represents a second action of the GUI, wherein determining the second action includes determining a second AOAV command representing the second textual data in AOAV command format;
determining the second AOAV command includes an ambiguity;
determining, using the first AOAV command, resolution data representing ambiguity resolution for the ambiguity;
updating the second AOAV command using the resolution data; and
executing the second AOAV command to cause the GUI to perform the second action.

2. The computer-implemented method of claim 1, wherein determining the resolution data further includes using mouse location data representing a location for a mouse cursor in the GUI.

3. The computer-implemented method of claim 1, wherein determining the resolution data further includes using historical data representing previous GUI interactions associated with the user.

4. The computer-implemented method of claim 1, wherein determining the second AOAV command includes the ambiguity, further comprises:
performing entity resolution for an object in the second AOAV command to determine a predicted object;
determining, using a model trained using domain-specific entities, a confidence score for the predicted object; and
determining the confidence score is below a predetermined ambiguity threshold.

5. The computer-implemented method of claim 1, wherein determining the resolution data includes validating the resolution data using a convolutional neural network (CNN) based object detection and object layout data of the GUI.

6. The computer-implemented method of claim 5, wherein the object layout data is updated using real-time detection and classification of element of the GUI.

7. The computer-implemented method of claim 1, further comprising:
receiving, concurrently with the first audio data, input data from a user input device;
determining a third action of the GUI corresponding to the input data; and
evaluating, based on historical user interaction patterns corresponding to the user, the first action and the third action to determine the first action has execution priority.

8. The computer-implemented method of claim 1, wherein determining the first action includes processing the first AOAV command to determine a first intent using a generative adversarial network (GAN) trained using previous execution data.

9. The computer-implemented method of claim 8, wherein the previous execution data used to train the GAN includes user feedback indicating success or failure of intended user input.

10. The computer-implemented method of claim 1, further comprising:
receiving third audio data representing a third natural-language spoken voice command from the user;
processing the third audio data to determine third textual data representing the third natural-language spoken voice command;
determining the third textual data represents a third action of the GUI, wherein determining the third action includes determining a third AOAV command representing the third textual data in AOAV command format;
determining the third AOAV command includes an ambiguity;
determining resolution processing data indicating an ambiguity resolution failure;
outputting, via the GUI, a prompt to the user to clarify the ambiguity;
receiving fourth audio data representing a spoken voice response from the user;
processing the fourth audio data to determine fourth textual data representing the spoken voice response;
updating the third AOAV command using the fourth textual data; and
executing the third AOAV command to cause the GUI to perform the third action.

11. A system for integrating voice commands with a graphical user interface (GUI), comprising:
at least one processor; and
at least one memory including instructions that, when executed by the at least one processor, cause the system to:
receive first audio data representing a first natural-language spoken voice command from a user;
process the first audio data to determine first textual data representing the first natural-language spoken voice command;
determine the first textual data represents a first action of the GUI, wherein determining the first action includes determining a first Action-Object-Attribute-Variable (AOAV) command representing the first textual data in AOAV command format;
execute the first AOAV command to cause the GUI to perform the first action;
receive second audio data representing a second natural-language spoken voice command from the user;
process the second audio data to determine second textual data representing the second natural-language spoken voice command;
determine the second textual data represents a second action of the GUI, wherein determining the second action includes determining a second AOAV command representing the second textual data in AOAV command format;
determine the second AOAV command includes an ambiguity;
determine, using the first AOAV command, resolution data representing ambiguity resolution for the ambiguity;
update the second AOAV command using the resolution data; and
execute the second AOAV command to cause the GUI to perform the second action.

12. The system of claim 11, wherein determining the resolution data further includes using mouse location data representing a location for a mouse cursor in the GUI.

13. The system of claim 11, wherein determining the resolution data further includes using historical data representing previous GUI interactions associated with the user.

14. The system of claim 11, wherein determining the second AOAV command includes the ambiguity and wherein the at least one memory further includes instructions that, when executed by the at least one processor, further cause the system to:
perform entity resolution for an object in the second AOAV command to determine a predicted object;
determine, using a model trained using domain-specific entities, a confidence score for the predicted object; and
determine the confidence score is below a predetermined ambiguity threshold.

15. The system of claim 11, wherein determining the resolution data includes validating the resolution data using a convolutional neural network (CNN) based object detection and object layout data of the GUI.

16. The system of claim 15, wherein the object layout data is updated using real-time detection and classification of element of the GUI.

17. The system of claim 11, wherein the at least one memory further includes instructions that, when executed by the at least one processor, further cause the system to:
receive, concurrently with the first audio data, input data from a user input device;
determine a third action of the GUI corresponding to the input data; and
evaluate, based on historical user interaction patterns corresponding to the user, the first action and the third action to determine the first action has execution priority.

18. The system of claim 11, wherein determining the first action includes processing the first AOAV command to determine a first intent using a generative adversarial network (GAN) trained using previous execution data.

19. The system of claim 18, wherein the previous execution data used to train the GAN includes user feedback indicating success or failure of intended user input.

20. The system of claim 11, wherein the at least one memory further includes instructions that, when executed by the at least one processor, further cause the system to:
receive third audio data representing a third natural-language spoken voice command from the user;
process the third audio data to determine third textual data representing the third natural-language spoken voice command;
determine the third textual data represents a third action of the GUI, wherein determining the third action includes determining a third AOAV command representing the third textual data in AOAV command format;
determine the third AOAV command includes an ambiguity;
determine resolution processing data indicating an ambiguity resolution failure;
output, via the GUI, a prompt to the user to clarify the ambiguity;
receive fourth audio data representing a spoken voice response from the user;
process the fourth audio data to determine fourth textual data representing the spoken voice response;
update the third AOAV command using the fourth textual data; and
execute the third AOAV command to cause the GUI to perform the third action.
